(19) United States
(12) Patent Application Publication
(10) Pub. No.: US 2013/0025486 A1
(43) Pub. Date: Jan. 31, 2013

(54) FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: Yuusuke KOZAWA, Shizuoka (JP)

(72) Inventor: Yuusuke KOZAWA, Shizuoka (JP)

(73) Assignee: FUJIFILM CORPORATION, Tokyo (JP)

(21) Appl. No.: 13/560,453

(22) Filed: Jul. 27, 2012

(30) Foreign Application Priority Data
Jul. 29, 2011 (JP) 2011-166860

(51) Int. Cl. B41N 1/00; B23K 26/00

(52) U.S. Cl. 101/395; 219/121.69

(57) ABSTRACT

Disclosed are a process for producing a flexographic printing plate precursor for laser engraving, the process including, in the following order, a thermally curable layer-forming step of forming a thermally curable layer comprising (Component A) a polymerizable compound, (Component B) a thermal polymerization initiator, and (Component C) a non-elastomeric binder; a hydrophilic resin layer-forming step of forming, on the thermally curable layer, a hydrophilic resin layer having a thickness of 10 μm to 40 μm, and an oxygen permeability at 25° C. and 1 atmosphere of 30 ml/m²·day·atm or less; and a crosslinking step of crosslinking the thermally curable layer by thermal curing; a flexographic printing plate precursor for laser engraving produced by the process; a process for making a flexographic printing plate; and a flexographic printing plate.

### TECHNICAL FIELD

The present invention relates to a flexographic printing plate precursor for laser engraving and a process for producing the same, and a flexographic printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder.

As the laser used in the system of plate making by directly engraving this relief-forming layer using a laser, inexpensive small-sized semiconductor lasers have been developed and used in addition to the high-power carbon dioxide lasers. The engraving residue of the relief-forming layer generated by the engraving using these lasers can be removed by a rinsing process or a water washing process, and examples of a flexographic printing plate precursor for laser engraving which allows easy removal of engraving residue are disclosed in JP-A-2008-229875 (JP-A denotes a Japanese unexamined patent application publication), JP-A-2010-94965, and JP-B-4323186 (JP-B denotes a Japanese examined patent application publication).

### SUMMARY OF THE INVENTION

In a flexographic printing plate precursor for laser engraving, when the engraving residue generated by laser engraving is removed, there is a problem that liquid viscous residue is produced on the engraved surface, and removal thereof is difficult to do. One of the causes is the influence on the polymerization reaction exerted by oxygen when the crosslinked relief-forming layer to be laser engraved is subjected to a crosslinking reaction (polymerization reaction of the polymerization composition). In a polymerizable composition that constitutes the relief-forming layer, the radicals generated from a polymerization initiator are deactivated when brought into contact with oxygen that is present in air, and there is a concern that the reaction of the polymerizable compound does not sufficiently proceed on the side of the surface of the relief-forming layer which is in contact with air (hereinafter, indicated as an oxygen-shielding layer surface). The presence of an unreacted polymerizable compound on this oxygen-shielding layer surface causes a viscous state on the oxygen-shielding layer surface side, making it easier for contaminants to adhere and making fine printing difficult. Also, the unreacted polymerizable compound causes a problem that residue (including liquid viscous matter) that is difficult to remove when the oxygen-shielding layer surface is engraved is generated in a large amount.

JP-A-2008-229875 discloses that a flexographic printing plate precursor, in which a hydrophilic resin layer is laminated on a crosslinkable resin layer containing a thermoplastic elastomeric binder, has excellent engraving residue cleanability, and the extent of thermal melting of the edges is small. On the other hand, it is known that a thermoplastic elastomeric binder cannot be engraved to a sharp shape due to thermal melting. When fine halftone dots of a size of about 10 μm are engraved, since the spacing between the halftone dots that are laser engraved is very narrow, even if the edges of halftone dot relief are slightly thermally melted, the height of the relief layer at the vertices of halftone dots is decreased compared to the height of the solid portion of the relief layer to be originally reproduced (hereinafter, this will be referred to as low-rising of the vertices of halftone dots). Thus, there is a concern regarding the problem that the print density may be affected, and the reproducibility of highlighted areas being insufficient.

An object of the present invention is to provide a flexographic printing plate precursor for laser engraving, in which low-rising of the vertices of halftone dots does not easily occur at the time of engraving fine halftone dots of a size of about 10 μm, excellent rinsability is exhibited, and contaminants do not easily adhere, and to provide a flexographic printing plate.

The object of the present invention described above was solved by the means described in the following items <1> and <8> to <10>. Preferred exemplary embodiments <2> to <7> and <11> to <17> are also described together below.

<1> A process for producing a flexographic printing plate precursor for laser engraving, the process comprising, in the following order, a thermally curable layer-forming step of forming a thermally curable layer comprising (Component A) a polymerizable compound, (Component B) a thermal polymerization initiator, and (Component C) a non-elastomeric binder; a hydrophilic resin layer-forming step of forming, on the thermally curable layer, a hydrophilic resin layer having a thickness of 10 μm to 40 μm, and an oxygen permeability at 25° C. and 1 atmosphere of 30 ml/m²·day·atm or less; and a crosslinking step of crosslinking the thermally curable layer by thermal curing;

<2> the process for producing a flexographic printing plate precursor for laser engraving as described in <1>, wherein the hydrophilic resin layer comprises an alkali-soluble resin;

<3> the process for producing a flexographic printing plate precursor for laser engraving as described in <1> or <2>, wherein the hydrophilic resin layer comprises at least one selected from the group consisting of polyvinyl alcohol (PVA), polyvinylpyrrolidone (PVP) and derivatives thereof;

<4> the process for producing a flexographic printing plate precursor for laser engraving as described in any one of <1> to <3>, wherein the hydrophilic resin layer comprises polyvinyl alcohol (PVA) or a derivative thereof, and polyvinylpyrrolidone (PVP) or a derivative thereof;

<5> the process for producing a flexographic printing plate precursor for laser engraving as described in <4>, wherein the weight ratio of the content of the polyvinyl alcohol (PVA) or a derivative thereof and the content of the polyvinylpyrrolidone (PVP) or a derivative thereof ((content of PVA or a derivative thereof)/(content of PVP or a derivative thereof)) contained in the hydrophilic resin layer is 4 to 10;

<6> the process for producing a flexographic printing plate precursor for laser engraving as described in any one of <1> to <5>, wherein the thermally curable layer further comprises (Component D) a compound having a hydrolyzable silyl group and/or a silanol group;

<7> the process for producing a flexographic printing plate precursor for laser engraving as described in any one of <1> to <6>, wherein the thickness of the hydrophilic resin layer is 20 μm to 40 μm;

<8> a process for making a flexographic printing plate, the process comprising, in the following order, the steps of: engraving a flexographic printing plate precursor for laser engraving produced according to the production process described in any one of <1> to <7> by laser exposure; and removing the engraving residue generated by engraving and the hydrophilic resin layer using a rinsing liquid;

<9> a flexographic printing plate made by the process for making a flexographic printing plate described in <8>;

<10> a flexographic printing plate precursor for laser engraving, comprising a relief-forming layer having a crosslinked structure formed by thermally crosslinking a thermally curable layer comprising (Component A) a polymerizable compound, (Component B) a thermal polymerization initiator, and (Component C) a non-elastomeric binder; and a hydrophilic resin layer having a thickness of 10 μm to 40 μm and an oxygen permeability at 25° C. and 1 atmosphere of 30 ml/m²·day·atm or less;

<11> the flexographic printing plate precursor for laser engraving as described in <10>, wherein the hydrophilic resin layer is alkali-soluble;

<12> the flexographic printing plate precursor for laser engraving as described in <10> or <11>, wherein the hydrophilic resin layer comprises an alkali-soluble resin;

<13> the flexographic printing plate precursor for laser engraving as described in any one of <10> to <12>, wherein the hydrophilic resin layer comprises at least one selected from the group consisting of polyvinyl alcohol (PVA), polyvinylpyrrolidone (PVP) and derivatives thereof;

<14> the flexographic printing plate precursor for laser engraving as described in any one of <10> to <13>, wherein the hydrophilic resin layer comprises a polyvinyl alcohol (PVA) or a derivative thereof, and polyvinylpyrrolidone (PVP) or a derivative thereof;

<15> the flexographic printing plate precursor for laser engraving as described in <14>, wherein the weight ratio of the content of the polyvinyl alcohol (PVA) or a derivative thereof and the content of the polyvinylpyrrolidone (PVP) or a derivative thereof ((content of PVA or a derivative thereof)/(content of PVP or a derivative thereof)) contained in the hydrophilic resin layer is 4 to 10;

<16> the flexographic printing plate precursor for laser engraving as described in any one of <10> to <15>, wherein the thermally curable layer further comprises (Component D) a compound having a hydrolyzable silyl group and/or a silanol group; and

<17> the flexographic printing plate precursor for laser engraving as described in any one of <10> to <16>, wherein the thickness of the hydrophilic resin layer is 20 μm to 40 μm.

### DESCRIPTION OF EMBODIMENTS

The present invention is explained in detail below.

In the present invention, the notation ‘lower limit to upper limit’ expressing a numerical range means ‘at least the lower limit but no greater than the upper limit’, and the notation ‘upper limit to lower limit’ means ‘no greater than the upper limit but at least the lower limit’. That is, they are numerical ranges that include the upper limit and the lower limit.

Further, “(Component A) a polymerizable compound” etc. may simply be called “Component A” etc.

The flexographic printing plate precursor for laser engraving of the present invention comprises a relief-forming layer having a crosslinked structure formed by thermally crosslinking a thermally curable layer comprising (Component A) a polymerizable compound, (Component B) a thermal polymerization initiator, and (Component C) a non-elastomeric binder; and a hydrophilic resin layer having a thickness of 10 μm to 40 μm and an oxygen permeability at 25° C. and 1 atmosphere of 30 ml/m²·day·atm or less.

The binder of Component C is a binder resin having a high molecular weight, and the thermally curable layer comprising Components A to C is also referred to as a thermally curable resin layer.

Although not clearly understood, the operating mechanism according to the present invention is speculated to be as follows.

It is known that the radicals generated from a radical polymerization initiator are deactivated when brought into contact with oxygen that is present in air, and the polymerizable compound is inhibited from undergoing a radical polymerization reaction. Thereby, on the oxygen-shielding layer surface (surface in contact with air) side, the polymerization reaction of the polymerizable compound does not completely proceed, and unreacted polymerizable compound may be present. In the flexographic printing plate precursor for laser engraving of the present invention, since the printing plate precursor has a hydrophilic resin layer having low oxygen permeability on a thermally curable resin layer, the contact with oxygen can be avoided, and the polymerizable compound can be made to sufficiently react even on the oxygen-shielding layer surface side. Accordingly, viscousness at the oxygen-shielding layer surface is low, and attachment of contaminants is reduced. Furthermore, as a hydrophilic resin layer is provided, during the process of washing engraving residue that has collected on the flexographic printing plate, highly viscous engraving residue that is difficult to remove by washing can be easily washed off together with the hydrophilic resin layer, and thus rinsability is enhanced to a great extent. Furthermore, it was found that in the present invention, when a non-elastomeric binder is selected as a polymer binder, low-rising of the vertices of halftone dots at the time of engraving fine halftone dots of a size of about 10 μm is improved as compared with the case of using a thermoplastic elastomeric binder. In the process of laser engraving, the polymer binder is engraved by being thermally degraded by the heat generated upon laser irradiation. Since the elastic modulus of the flexographic printing plate at the plate temperature reached due to the heat is higher in a non-elastomeric binder than in a thermoplastic elastomeric binder, it is speculated that even if the spacing of laser irradiation is narrow, thermal melting of the edge area of the engraved relief layer does not easily occur, and highly accurate printing is enabled.

As discussed above, when a thermally curable resin layer comprising a non-elastomeric binder and a hydrophilic resin layer are provided, a flexographic printing plate precursor for laser engraving in which the polymerizable compound sufficiently reacts to be chemically reinforced, a reduction in thermal melting of the edge areas can be realized, excellent rinsability is exhibited, and low-rising of the vertices of halftone dots at the time of engraving fine halftone dots of a size of about 10 μm and attachment of contaminants do not easily occur, can be provided.

In the present specification, when a flexographic printing plate precursor is explained, a layer that serves as an image-forming layer subjected to laser engraving, that has a flat surface, and that is an uncrosslinked or crosslinked thermally curable layer (which is also called a crosslinkable layer) is called a relief-forming layer, and a layer that has asperities formed on the surface by laser engraving the crosslinked relief-forming layer is called a relief layer.

Constituent components of the thermally curable layer of the flexographic printing plate precursor for laser engraving are explained below.

### (Thermally Curable Layer)

The flexographic printing plate precursor for laser engraving of the present invention has a relief-forming layer having a crosslinked structure formed by thermally crosslinking a thermally curable layer (also called a thermally curable resin composition layer) comprising (Component A) a polymerizable compound, (Component B) a thermal polymerization initiator, and (Component C) a non-elastomeric binder.

Components A to C of the thermally curable resin composition included in the thermally curable layer will be described below.

### <(Component A) Polymerizable Compound>

The thermally curable resin composition used in the present invention comprises (Component A) a polymerizable compound. The polymerizable compound is not particularly limited, and any polymerizable compound that is well known to those ordinarily skilled in the art can be used. Preferably, a polymerizable compound having at least one ethylenically unsaturated bond can be used.

A polymerizable compound having at least one ethylenically unsaturated bond that is a preferred polymerizable compound used in the present invention, is selected from compounds having at least one, and preferably two or more, ethylenically unsaturated bonds. Such a group of compounds is widely known in the present industrial field, and they may be used in the present invention without particular limitations. They have a chemical form such as, for example, a monomer, a prepolymer such as a dimer or a trimer, an oligomer, a mixture thereof, or a copolymer thereof.

Examples of the monomer and the copolymer thereof include unsaturated carboxylic acids (e.g. acrylic acid, methacrylic acid, itaconic acid, crotonic acid, isocrotonic acid, maleic acid, etc.), esters thereof, and amides thereof, and an ester of an unsaturated carboxylic acid and an aliphatic polyhydric alcohol compound or an amide of an unsaturated carboxylic acid and an aliphatic polyamine compound is preferably used. Furthermore, an addition reaction product of an unsaturated carboxylic acid ester or amide having a nucleophilic substituent such as a hydroxy group, an amino group, or a mercapto group with a monofunctional or polyfunctional isocyanate or epoxy compound, and a dehydration-condensation reaction product between an unsaturated carboxylic acid ester or amide having the above nucleophilic substituent and a monofunctional or polyfunctional carboxylic acid, etc. may also be used suitably. Furthermore, an addition reaction product of an unsaturated carboxylic acid ester or amide having an electrophilic substituent such as an isocyanato group or an epoxy group with a monofunctional or polyfunctional alcohol, amine, or thiol, and a substitution reaction product of an unsaturated carboxylic acid ester or amide having a leaving substituent such as a halogen atom or a tosyloxy group with a monofunctional or polyfunctional alcohol, amine, or thiol are also suitable. Furthermore, as other examples, a group of compounds in which the above-mentioned unsaturated carboxylic acid is replaced by an unsaturated phosphonic acid, styrene, vinyl ether, etc. may also be used.

Examples of the monofunctional polymerizable compound preferably used include (meth)acrylic acid derivatives such as methyl (meth)acrylate, ethyl (meth)acrylate, n-butyl (meth)acrylate, 2-ethylhexyl (meth)acrylate, 2-hydroxyethyl (meth)acrylate, butoxyethyl (meth)acrylate, carbitol (meth)acrylate, cyclohexyl (meth)acrylate, benzyl (meth)acrylate, N-methylol (meth)acrylamide, and epoxy (meth)acrylate, N-vinyl compounds such as N-vinylpyrrolidone and N-vinylcaprolactam, and allyl compounds such as allyl glycidyl ether, diallyl phthalate, and triallyl trimellitate.

Specific examples of the monomer that is an ester of an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer. Among them, dipentaerythritol hexaacrylate is preferable.

Examples of methacrylic acid esters include diethylene glycol dimethacrylate, tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane, tricyclodecanedimetanol dimethacrylate. Among them, diethylene glycol dimethacrylate and tricyclodecanedimetanol dimethacrylate are preferable.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

As examples of other esters, aliphatic alcohol-based esters described in JP-B-46-27926, JP-B-51-47334, and JP-A-57-196231, those having an aromatic skeleton described in JP-A-59-5240, JP-A-59-5241, and JP-A-2-226149, those having an amino group described in JP-A-1-165613, etc. may also be used suitably.

Moreover, the above-mentioned ester monomers may be used as a mixture.

Furthermore, specific examples of monomers that are amides of an aliphatic polyvalent amine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include cyclohexylene structure-containing ones described in JP-B-54-21726.

Furthermore, a urethane-based polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (I) below is added to a polyisocyanate compound having two or more isocyanato groups per molecule described in JP-B-48-41708.

CH₂═C(R)COOCH₂CH(R′)OH (I)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, and JP-B-62-39418 are also suitable.

Furthermore, a photosensitive composition having extremely good photosensitive speed can be obtained by the use of polymerizable compounds having an amino structure or a sulfide structure in the molecule described in JP-A-63-277653, JP-A-63-260909, and JP-A-1-105238.

Other examples include polyfunctional acrylates and methacrylates, for example, polyester (meth)acrylates and epoxy (meth)acrylates obtained by reacting an epoxy resin with (meth)acrylic acid that are described in JP-A-48-64183, JP-B-49-43191, and JP-B-52-30490. Further examples include specific unsaturated compounds described in JP-B-46-43946, JP-B-1-40337, and JP-B-1-40336 and vinylphosphonic acid-based compounds described in JP-A-2-25493. In some cases, a perfluoroalkyl group-containing structure described in JP-A-61-22048 is suitably used. Moreover, photocurable monomers or oligomers described in Nippon Secchaku Kyokaishi (Journal of Japan Adhesion Society), Vol. 20, No. 7, pp. 300-308 (1984) can also be used.

From the viewpoint of photosensitive speed, a structure having a large unsaturated group content per molecule is preferable, and in many cases di- or higher-functionality is preferable. And in order to improve strength of an image area that is a cured film, tri- or higher-functionality is preferable. Furthermore, it is effective to adjust both photosensitivity and strength by using in combination different functionality/different polymerizable groups (e.g. an acrylic acid ester, a methacrylic acid ester, a styrene-based compound, a vinyl ether-based compound).

Component A is used at a content in the range of preferably 5 wt % to 80 wt %, and more preferably 5 wt % to 60 wt %, relative to the total solid weight of the thermally curable layer. Furthermore, Component A may be used singly, or two or more kinds may be used in combination.

### <(Component B) Thermal Polymerization Initiator>

The thermally curable resin composition used in the present invention comprises (Component B) a thermal polymerization initiator. The thermal polymerization initiator is not particularly limited, and any thermal polymerization initiator that is known to those ordinarily skilled in the art can be used without limitations. Preferably, a radical polymerization initiator may be used. Hereinafter, a radical polymerization initiator which is a preferred thermal polymerization initiator will be described in detail.

Examples of the radical polymerization initiator include an aromatic ketone, an onium salt compound, an organic peroxide, a thio compound, a hexaarylbiimidazole compound, a ketoxime ester compound, a borate compound, an azinium compound, a metallocene compound, an active ester compound, a carbon-halogen bond-containing compound, and an azo-based compound.

In the present invention, when applies to the relief-forming layer of the flexographic printing plate precursor, from the viewpoint of engraving sensitivity and making a favorable relief edge shape, organic peroxides and azo compounds are more preferable, and organic peroxides are particularly preferable. Compounds shown below are preferable as organic peroxides and azo compounds.

### Organic Peroxides

Preferable organic peroxides as a radical polymerization initiator that can be used in the present invention include a peroxide ester such as 3,3′,4,4′-tetra (tertiary-butylperoxycarbonyl)benzophenone, 3,3′,4,4′-tetra(tertiary-amylperoxycarbonyl)benzophenone, 3,3′,4,4′-tetra(tertiary-hexylperoxycarbonyl)benzophenone, 3,3′,4,4′-tetra(tertiary-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone di-tertiary-butyldiperoxyisophthalate, and tertiary-butylperoxybenzoate.

### Azo Compounds

Preferable azo compounds as a radical polymerization initiator that can be used in the present invention include 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

With regard to Component B in the present invention, one type may be used on its own or two or more types may be used in combination.

The content of Component B is preferably 0.01 to 15 wt % relative to the total content by weight of Component A in a thermally curable layer, and more preferably 0.02 to 10 wt %. When the content of the polymerization initiator is at least 0.01 wt %, an effect from the addition thereof is obtained, and crosslinking of a crosslinkable relief-forming layer proceeds promptly. Furthermore, when the content is no greater than 15 wt %, other components do not become insufficient, and printing durability that is satisfactory as a flexographic printing plate is obtained.

### <(Component C) Non-Elastomeric Binder>

The thermally curable resin composition used in the present invention comprises (Component C) a non-elastomeric binder.

The non-elastomeric binder refers to a binder polymer having a glass transition temperature (Tg) of 20° C. or higher. That is, generally, an elastomer is academically defined as a polymer having a glass transition temperature of no greater than room temperature (ref. Kagaku Dai Jiten 2^{nd} edition (Science Dictionary), Foundation for Advancement of International Science, Maruzen, pp. 154). Non-elastomeric polymer refers to a polymer which has a glass transition temperature of greater than room temperature. The upper limit for the glass transition temperature of the binder polymer is not limited, but is preferably no greater than 200° C. from the viewpoint of ease of handling, and is more preferably at least 25° C. but no greater than 120° C.

A polymer having a glass transition temperature of room temperature (20° C.) or greater is in a glass state at normal temperature. Because of this, compared with a case of the rubber state (an elastomer), thermal molecular motion is suppressed. In laser engraving, it is surmised that in addition to the heat given by a laser during laser irradiation, heat generated by the function of a photothermal conversion agent explained later is transmitted to the surrounding crosslinked structure, and this is thermally decomposed and disappears, thereby forming an engraved recess.

In a case of using non-elastomeric binder, it is surmised that when a photothermal conversion agent is present in a state in which thermal molecular motion of the non-elasomeric binder is suppressed, heat transfer to and thermal decomposition of the non-elasomeric binder occur effectively. It is anticipated that such an effect further result in a fine flexographic printing plate with a sharp shape.

Specific examples of the polymer as a non-elastomeric binder that is preferably used in the present invention will be listed below. As the polymer as a non-elastomeric binder that is preferably used in the present invention, in the case of using the polymer for the purpose of curing the polymer by heating or light exposure and thereby enhancing the strength, a polymer having a reactive functional group such as a hydroxyl group, an alkoxy group, a hydrolyzable silyl group and/or a silanol group, or an ethylenically unsaturated group in the molecule is preferably used.

The above reactive functional group may be present at any locations in polymer molecules, but is preferably present at the side chain of the branched polymer. Preferred examples of such a polymer include a vinyl copolymer (copolymer of a vinyl monomer such as polyvinyl alcohol and polyvinyl acetal, and a derivative thereof) and an acrylic resin (copolymer of an acryl-based monomer such as hydroxyethyl(meth)acrylate, and a derivative thereof).

A method of introducing the reactive functional group into the binder polymer is not particularly limited, and a method of addition-(co)polymerizing or addition-polycondensating a monomer having the reactive functional group and a method in which, after synthesizing a polymer having a group which can be introduced into the reactive functional group, the group of the polymer is introduced into the reactive functional group by polymer reaction are included thereto.

As a binder polymer having the reactive group in a molecule, a binder polymer having a hydroxyl group is preferably used. The binder polymer having a hydroxyl group is explained below.

A binder polymer having a hydroxy group (hereinafter, if necessary, also referred to as a “specific polymer”) is preferably insoluble in water and soluble in alcohol having 1 to 4 carbon atoms. Specific examples include polyvinyl acetal and derivatives thereof, acrylic resins having a hydroxy group on a side chain, and epoxy resins having a hydroxy group on a side chain, etc. Specific examples are explained below.

### 1. Polyvinyl Acetal and its Derivative

Polyvinyl acetal that can be used as a non-elastomeric binder is preferably a compound obtained by converting polyvinyl alcohol (obtained by saponifying polyvinyl acetate) into a cyclic acetal. The polyvinyl acetal derivative is preferably a derivative obtained by modifying the polyvinyl acetal or adding another copolymer constituent.

The acetal content in the polyvinyl acetal derivative (mole % of vinyl alcohol units converted into acetal relative to the total number of moles of vinyl acetate monomer starting material as 100 mole %) is preferably 30 to 90 mole %, more preferably 50 to 85 mole %, and particularly preferably 55 to 78 mole %.

The vinyl alcohol unit in the polyvinyl acetal derivatives is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may have a vinyl acetate unit as another component, and the content thereof is preferably 0.01 to 20 mole %, and more preferably 0.1 to 10 mole %. The polyvinyl acetal derivative may further have another copolymerized constitutional unit.

Examples of the polyvinyl acetal include polyvinyl butyral, polyvinyl propylal, polyvinyl ethylal, and polyvinyl methylal. Among them, polyvinyl butyral derivative (PVB) is particularly preferably used.

Polyvinyl butyral is conventionally obtained by converting polyvinyl alcohol into polyvinyl bytyral. Polyvinyl butyral derivatives may be also used.

Examples of the polyvinyl butyral derivatives include an acid-modified PVB in which at least some of the hydroxy groups are modified with an acid group such as a carboxy group, a modified PVB in which some of the hydroxy groups are modified with a (meth)acryloyl group, a modified PVB in which at least some of the hydroxy groups are modified with an amino group, a modified PVB in which at least some of the hydroxy groups have introduced thereinto ethylene glycol, propylene glycol, or a multimer thereof.

From the viewpoint of a balance being achieved between engraving sensitivity and film formation properties, the weight-average molecular weight of the polyvinyl acetal is preferably 5,000 to 800,000, more preferably 8,000 to 500,000 and, from the viewpoint of improvement of rinsing properties for engraving residue, particularly preferably 50,000 to 300,000.

Hereinafter, polyvinyl butyral (PVB) and derivatives thereof are cited for explanation as particularly preferred examples of polyvinyl acetal, but are not limited to these.

Polyvinyl butyral has a structure as shown below, and is constituted while including these structural units.

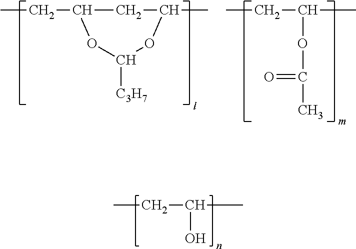

In the above Formula, l, m, and n denote the content (mole %) in polyvinyl butyral of the respective repeating units and the relationship l+m+n=100 is satisfied. The butyral content in the polyvinyl butyral and the derivative thereof (value of l in the formula above) is preferably 30 to 90 mole %, more preferably 50 to 85 mole %, and particularly preferably 55 to 78 mole %.

From the viewpoint of a balance being achieved between engraving sensitivity and film formation properties, the weight-average molecular weight of the polyvinyl butyral and the derivative thereof is preferably 5,000 to 800,000, more preferably 8,000 to 500,000 and, from the viewpoint of improvement of rinsing properties for engraving residue, particularly preferably 50,000 to 300,000.

The PVB derivative is also available as a commercial product, and preferred examples thereof include, from the viewpoint of alcohol (particularly, ethanol) dissolving capability, “S-REC B” series and “S-REC K (KS)” series manufactured by SEKISUI CHEMICAL CO., LTD. and “DENKA BUTYRAL” manufactured by DENKI KAGAKU KOGYO KABUSHIKI KAISHA. From the viewpoint of alcohol (particularly, ethanol) dissolving capability, “S-REC B” series manufactured by SEKISUI CHEMICAL CO., LTD. and “DENKA BUTYRAL” manufactured by DENKI KAGAKU KOGYO KABUSHIKI KAISHA are more preferable. Among these, particularly preferable commercial products are shown below along with the values l, m, and n in the above formulae and the molar weight. Examples of “S-REC B” series manufactured by SEKISUI CHEMICAL CO., LTD. include “BL-1” (l=61, m=3, n=36, weight-average molecular weight: 19,000), “BL-1H” (l=67, m=3, n=30, weight-average molecular weight: 20,000), “BL-2” (l=61, m=3, n=36, weight-average molecular weight: about 27,000), “BL-5” (l=75, m=4, n=21, weight-average molecular weight: 32,000), “BL-S” (l=74, m=4, n=22, weight-average molecular weight: 23,000), “BM-S” (l=73, m=5, n=22, weight-average molecular weight: 53,000), and “BH-S” (l=73, m=5, n=22, weight-average molecular weight: 66,000), and examples of “DENKA BUTYRAL” manufactured by DENKI KAGAKU KOGYO include “#3000-1” (l=71, m=1, n=28, weight-average molecular weight: 74,000), “#3000-2” (l=71, m=1, n=28, weight-average molecular weight: 90,000), “#3000-4” (l=71, m=1, n=28, weight-average molecular weight: 117,000), “#4000-2” (l=71, m=1, n=28, weight-average molecular weight: 152,000), “#6000-C” (l=64, m=1, n=35, weight-average molecular weight: 308,000), “#6000-EP” (l=56, m=15, n=29, weight-average molecular weight: 381,000), “#6000-CS” (l=74, m=1, n=25, weight-average molecular weight: 322,000), and “#6000-AS” (l=73, m=1, n=26, weight-average molecular weight: 242,000).

When the relief-forming layer is formed using the PVB derivative as a specific polymer, a method of casting and drying a solution in which a solvent is dissolved is preferable from the viewpoint of smoothness of the film surface.

### 2. Acrylic Resin

An acrylic resin that can be used as a non-elastomeric binder is preferably an acrylic resin which can be synthesized from a known (meth)acrylic monomer and has a hydroxy group in the molecule.

Preferred examples of the (meth)acrylic monomer used for synthesizing the acrylic resin having a hydroxy group include for example a (meth)acrylic acid ester, a crotonic acid ester, or a (meth)acrylamide that has a hydroxy group in the molecule. Specific examples of such a monomer include 2-hydroxyethyl (meth)acrylate, 2-hydroxypropyl (meth)acrylate, and 4-hydroxybutyl (meth)acrylate.

In the present invention ‘(meth)acryl’ means ‘acryl’ and/or ‘methacryl’ and ‘(meth)acrylate’ means ‘acrylate’ and/or ‘methacrylate.’

The acrylic resin may be constituted from a known acrylic comonomer other than the (meth)acrylic monomer having a hydroxy group explained above. Examples of the (meth)acrylic monomer include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-hexyl (meth)acrylate, lauryl (meth)acrylate, 2-ethylhexyl (meth)acrylate, acetoxyethyl (meth)acrylate, phenyl (meth)acrylate, 2-methoxyethyl (meth)acrylate, 2-ethoxyethyl (meth)acrylate, 2-(2-methoxyethoxy)ethyl (meth)acrylate, cyclohexyl (meth)acrylate, t-butylcyclohexyl (meth)acrylate, benzyl (meth)acrylate, diethylene glycol monomethyl ether (meth)acrylate, diethylene glycol monoethyl ether (meth)acrylate, diethylene glycol monophenyl ether (meth)acrylate, triethylene glycol monomethyl ether (meth)acrylate, triethylene glycol monoethyl ether (meth)acrylate, dipropylene glycol monomethyl ether (meth)acrylate, polyethylene glycol monomethyl ether (meth)acrylate, polypropylene glycol monomethyl ether (meth)acrylate, the monomethyl ether (meth)acrylate of a copolymer of ethylene glycol and propylene glycol, N,N-dimethylaminoethyl (meth)acrylate, N,N-diethylaminoethyl (meth)acrylate, and N,N-dimethylaminopropyl (meth)acrylate.

Furthermore, a modified acrylic resin formed with a urethane group- or urea group-containing acrylic monomer may preferably be used.

Among these, from the viewpoint of aqueous ink resistance, an alkyl (meth)acrylate such as lauryl (meth)acrylate and an aliphatic cyclic structure-containing (meth)acrylate such as t-butylcyclohexyl (meth)acrylate are particularly preferable.

### 3. Novolac Resin

Furthermore, as the non-elastomeric binder, a novolac resin may be preferably used, this being a resin formed by condensation of a phenol and an aldehyde under acidic conditions.

Preferred examples of the novolac resin include a novolac resin obtained from phenol and formaldehyde, a novolac resin obtained from m-cresol and formaldehyde, a novolac resin obtained from p-cresol and formaldehyde, a novolac resin obtained from o-cresol and formaldehyde, a novolac resin obtained from octylphenol and formaldehyde, a novolac resin obtained from mixed m-/p-cresol and formaldehyde, and a novolac resin obtained from a mixture of phenol/cresol (any of m-, p-, o- or m-/p-, m-/o-, o-/p-mixtures) and formaldehyde.

With regard to these novolac resins, those having a weight-average molecular weight of 800 to 200,000 and a number-average molecular weight of 400 to 60,000 are preferable.

An epoxy resin having a hydroxy group in a side chain may be used as a non-elastomeric binder. A preferred example of the epoxy resin include an epoxy resin formed by polymerization, as a starting material monomer, of an adduct of bisphenol A and epichlorohydrin.

The epoxy resin preferably has a weight-average molecular weight of 800 to 200,000, and a number-average molecular weight of 400 to 60,000.

Among non-elastomeric binders, polyvinyl butyral derivatives are more preferable from the viewpoint of rinsing properties and printing durability when the binder is formed into the relief-forming layer.

In non-elastomeric binders of any embodiment described above, the content of the hydroxyl group contained in the non-elastomeric binders in the present invention is preferably 0.1 to 15 mmol/g, and more preferably 0.5 to 7 mmol/g.

In the thermally curable resin composition used in the present invention, in addition to the non-elastomeric binder, known polymers that are not included in the non-elastomeric binder can be used in combination. Hereinafter, such a polymer may also be called a general polymer.

The general polymer constitutes the thermally curable resin composition included in the flexographic printing plate precursor for laser engraving, together with the non-elastomeric binder, and therefore, one kind or two or more kinds of general polymer compounds that are not included in the non-elastomeric binder can be appropriately selected and used. Particularly, when a flexographic printing plate precursor is used as a printing plate precursor, it is necessary to select a binder polymer while taking into consideration various performances such as laser engraving properties, ink acceptability, and engraving residue dispersibility.

The general polymer may be selected from polystyrene resin, polyester resin, polyamide resin, polyureapolyamideimide resin, polyurethane resin, polysulfone resin, polyether sulfone resin, polyimide resin, polycarbonate resin, hydroxyethylene unit-containing hydrophilic polymer, acrylic resin, acetal resin, polycarbonate resin, rubber, thermoplastic elastomer, etc.

For example, from the viewpoint of the laser engraving sensitivity, polymers having a partial structure capable of being thermally decomposed by exposure or heating are preferable. Examples of such polymers preferably include those described in JP-A-2008-163081, paragraph 0038.

With regard to Component C in the thermally curable resin composition used in the present invention, only one type may be used or two or more types may be used in combination.

The content of Component C contained in the thermally curable layer used in the present invention is, from the viewpoint of a balance being obtained between shape retention, water resistance, and engraving sensitivity of a coating, preferably 2 to 95 wt % of the total solids content of the thermally curable layer used in the present invention, more preferably 5 to 80 wt %, and particularly preferably 10 to 60 wt %.

<(Component D) Compound Having Hydrolyzable Silyl Group and/or Silanol Group>

The thermally curable resin composition used in the present invention may preferably comprise (Component D) a compound having a hydrolyzable silyl group and/or a silanol group in addition to Component A to Component C.

The ‘hydrolyzable silyl group’ of (Component D) a compound having a hydrolyzable silyl group and/or a silanol group (hereinafter, called ‘Component D’ as appropriate) preferably used in the thermally curable resin composition used in the present invention is a silyl group that has a hydrolyzable group; examples of hydrolyzable groups include an alkoxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or a silanol group is preferably one represented by Formula (I) below.

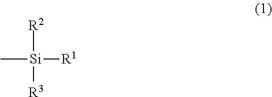

In Formula (I) above, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group; The remainder of R¹ to R³ independently denotes a hydrogen atom, a halogen atom, or a monovalent organic substituent (examples including an alkyl group, an aryl group, an alkenyl group, an alkynyl group, and an aralkyl group).

In Formula (1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Clatom, a Br atom, and an I atom, and from the viewpoint of ease of synthesis and stability it is preferably a Cl atom or a Br atom, and more preferably a Cl atom.

Component D in the present invention is preferably a compound having one or more groups represented by Formula (1) above, and more preferably a compound having two or more. A compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in Component D is preferably at least 2 but no greater than 6, and most preferably 2 or 3.

A range of 1 to 4 of the hydrolyzable groups may bond to one silicon atom, and the total number of hydrolyzable groups in Formula (I) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

Component D preferably has at least a sulfur atom, an ester bond, a urethane bond, an ether bond, a urea bond, or an imino group.

Among them, from the viewpoint of crosslinkability, Component D preferably comprises a sulfur atom, and from the viewpoint of removability (rinsing properties) of engraving residue it is preferable for it to comprise an ester bond, a urethane bond, or an ether bond (in particular, an ether bond contained in an oxyalkylene group), which are easily decomposed by aqueous alkali.

Component D containing a sulfur atom functions as a vulcanizing agent or a vulcanization accelerator at the time of vulcanization treatment, and accelerates the reaction (crosslinking) of the polymer containing a conjugated diene monomer unit. As a result, Component D exhibits rubber elasticity that is needed as a flexographic printing plate. Also, Component D enhances the strength of the crosslinked relief-forming layer and the relief layer.

Furthermore, Component D according to the present invention is preferably a compound which does not have an ethylenically unsaturated bond.

As Component D in the present invention, there can be preferably cited a compound in which a plurality of groups represented by Formula (1) above are bonded via a divalent linking group, and from the viewpoint of the effect, such a divalent linking group is preferably a linking group having a sulfide group (—S—), an imino group (—N(R)—), a urea group, or a urethane bond (—OCON(R)— or —N(R)COO—). R denotes a hydrogen atom or a substituent. Examples of the substituent denoted by R include an alkyl group, an aryl group, an alkenyl group, an alkynyl group, and an aralkyl group.

A method for synthesizing Component D is not particularly limited, and synthesis can be carried out by a known method. As one example, a representative synthetic method for a Component D containing a linking group having the above-mentioned specific structure is shown below.

<Synthetic Method for Compound Having Sulfide Group as Linking Group and Having Hydrolyzable Silyl Group and/or Silanol Group>

A synthetic method for a Component D having a sulfide group as a linking group (hereinafter, called as appropriate a ‘sulfide linking group-containing Component D’) is not particularly limited, but specific examples thereof include reaction of a Component D having a halogenated hydrocarbon group with an alkali metal sulfide, reaction of a Component D having a mercapto group with a halogenated hydrocarbon, reaction of a Component D having a mercapto group with a Component D having a halogenated hydrocarbon group, reaction of a Component D having a halogenated hydrocarbon group with a mercaptan, reaction of a Component D having an ethylenically unsaturated double bond with a mercaptan, reaction of a Component D having an ethylenically unsaturated double bond with a Component D having a mercapto group, reaction of a compound having an ethylenically unsaturated double bond with a Component D having a mercapto group, reaction of a ketone with a Component D having a mercapto group, reaction of a diazonium salt with a Component D having a mercapto group, reaction of a Component D having a mercapto group with an oxirane, reaction of a Component D having a mercapto group with a Component D having an oxirane group, reaction of a mercaptan with a Component D having an oxirane group, and reaction of a Component D having a mercapto group with an aziridine.

<Synthetic Method for Compound Having Imino Group as Linking Group and Having Hydrolyzable Silyl Group and/or Silanol Group>

A synthetic method for a Component D having an imino group as a linking group (hereinafter, called as appropriate an ‘imino linking group-containing Component D’) is not particularly limited, but specific examples include reaction of a Component D having an amino group with a halogenated hydrocarbon, reaction of a Component D having an amino group with a Component D having a halogenated hydrocarbon group, reaction of a Component D having a halogenated hydrocarbon group with an amine, reaction of a Component D having an amino group with an oxirane, reaction of a Component D having an amino group with a Component D having an oxirane group, reaction of an amine with a Component D having an oxirane group, reaction of a Component D having an amino group with an aziridine, reaction of a Component D having an ethylenically unsaturated double bond with an amine, reaction of a Component D having an ethylenically eunsaturated double bond with a Component D having an amino group, reaction of a compound having an ethylenically unsaturated double bond with a Component D having an amino group, reaction of a compound having an acetylenically unsaturated triple bond with a Component D having an amino group, reaction of a Component D having an imine-based unsaturated double bond with an organic alkali metal compound, reaction of a Component D having an imine-based unsaturated double bond with an organic alkaline earth metal compound, and reaction of a carbonyl compound with a Component D having an amino group.

<Synthetic Method for Compound Having Urea Bond as Linking Group and Having Hydrolyzable Silyl Group and/or Silanol Group>

A synthetic method for Component D having an urea bond (hereinafter, called as appropriate a ‘urea linking group-containing Component D’) as a linking group is not particularly limited, but specific examples include synthetic methods such as reaction of a Component D having an amino group with an isocyanate ester, reaction of a Component D having an amino group with a Component D having an isocyanate ester, and reaction of an amine with a Component D having an isocyanate ester.

Component D is preferably a compound represented by Formula (A-1) or Formula (A-2) below.

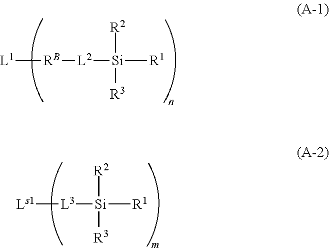

(In Formula (A-1) and Formula (A-2), R^{B} denotes an ester bond, an amide bond, a urethane bond, a urea bond, or an imino group, L¹ denotes an n-valent linking group, L² denotes a divalent linking group, L^{s1} denotes an m-valent linking group, L³ denotes a divalent linking group, n and m independently denote an integer of 1 or greater, and R¹ to R³ independently denote a hydrogen atom, a halogen atom, or a monovalent organic substituent. In addition, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group.)

R¹ to R³ in Formula (A-1) and Formula (A-2) above have the same meanings as those of R¹ to R³ in Formula (1) above, and preferred ranges are also the same.

From the viewpoint of rinsing properties and film strength, R^{B} above is preferably an ester bond or a urethane bond, and is more preferably an ester bond.

The divalent or n-valent linking group denoted by L¹ to L³ above is preferably a group formed from at least one type of atom selected from the group consisting of a carbon atom, a hydrogen atom, an oxygen atom, a nitrogen atom, and a sulfur atom, and is more preferably a group formed from at least one type of atom selected from the group consisting of a carbon atom, a hydrogen atom, an oxygen atom, and a sulfur atom. The number of carbon atoms of L¹ to L³ above is preferably 2 to 60, and more preferably 2 to 30.

The m-valent linking group denoted by L^{s1} above is preferably a group formed from a sulfur atom and at least one type of atom selected from the group consisting of a carbon atom, a hydrogen atom, an oxygen atom, a nitrogen atom, and a sulfur atom, and is more preferably an alkylene group or a group formed by combining two or more from an alkylene group, a sulfide group, and an imino group. The number of carbon atoms of L^{s1} above is preferably 2 to 60, and more preferably 6 to 30.

n and m above are independently integers of 1 to 10, more preferably integers of 2 to 10, yet more preferably integers of 2 to 6, and particularly preferably 2.

From the viewpoint of removability (rinsing properties) of engraving residue, the n-valent linking group denoted by L¹ and/or the divalent linking group denoted by L², or the divalent linking group denoted by L³ preferably has an ether bond, and more preferably has an ether bond contained in an oxyalkylene group.

Among compounds represented by Formula (A-1) or Formula (A-2), from the viewpoint of crosslinkability, etc., the n-valent linking group denoted by L¹ and/or the divalent linking group denoted by L² in Formula (A-1) are preferably groups having a sulfur atom.

Specific examples of Component D that can be applied to the present invention are shown below. Examples thereof include vinyltrichlorosilane, vinyltrimethoxysilane, vinyltriethoxysilane, β-(3,4-epoxycyclohexyl)ethyltrimethoxysilane, γ-glycidoxypropyltrimethoxysi lane, γ-glycidoxypropylmethyldiethoxysilane, γ-glycidoxypropyltriethoxysilane, γ-methacryloxypropylmethyldimethoxysilane, p-styryltrimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, mercaptomethyltrimethoxysilane, dimethoxy-3-mercaptopropylmethylsilane, 2-(2-aminoethylthioethyl)diethoxymethylsilane, 3-(2-acetoxyethylthiopropyl)dimethoxymethylsilane, 2-(2-aminoethylthioethyl)triethoxysilane, dimethoxymethyl-3-(3-phenoxypropylthiopropyl)silane, bis(triethoxysilylpropyl)disulfide, bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-ureidopropyltriethoxysilane, trimethylsilanol, diphenylsilanediol, and triphenylsilanol. Other than the above, the compounds shown below can be cited as preferred examples, but the present invention should not be construed as being limited thereto.

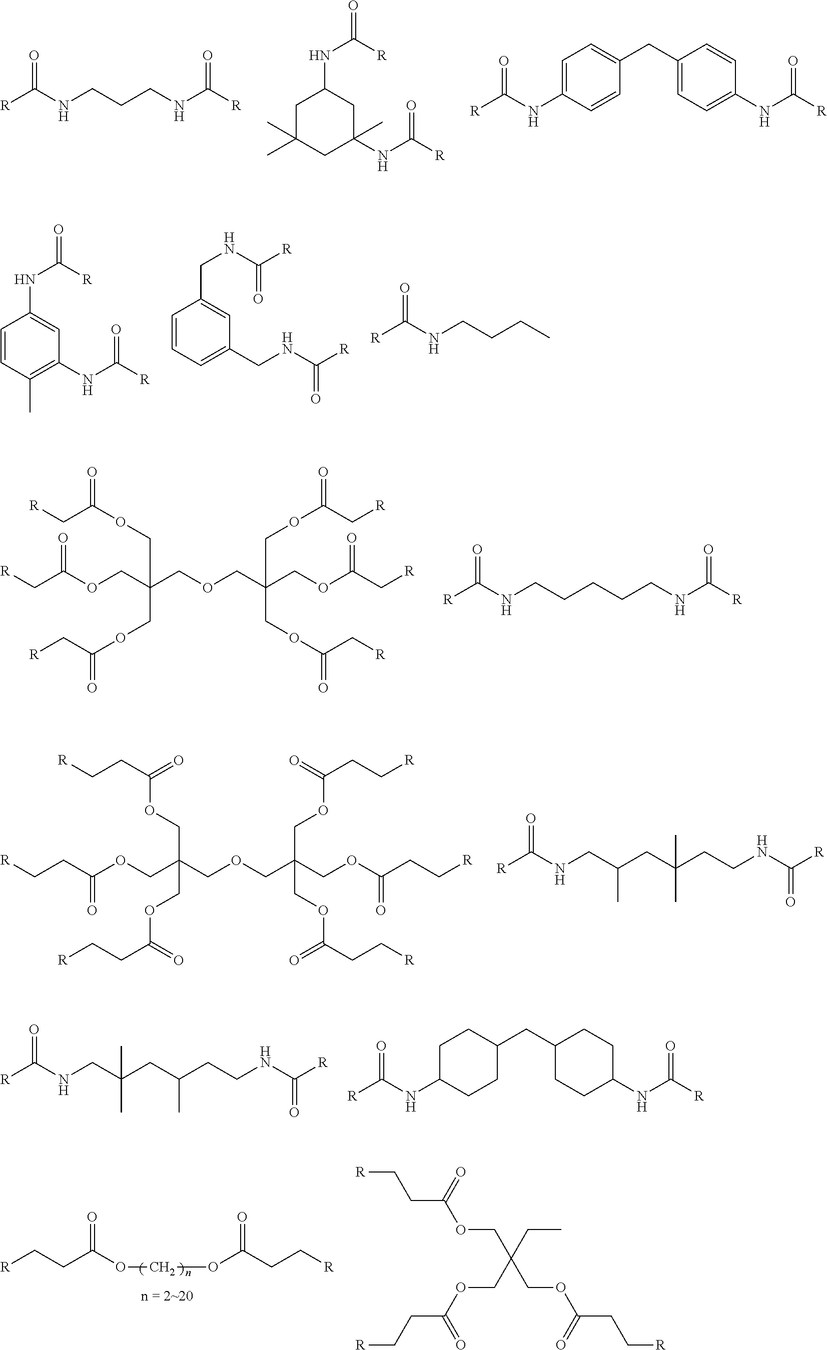

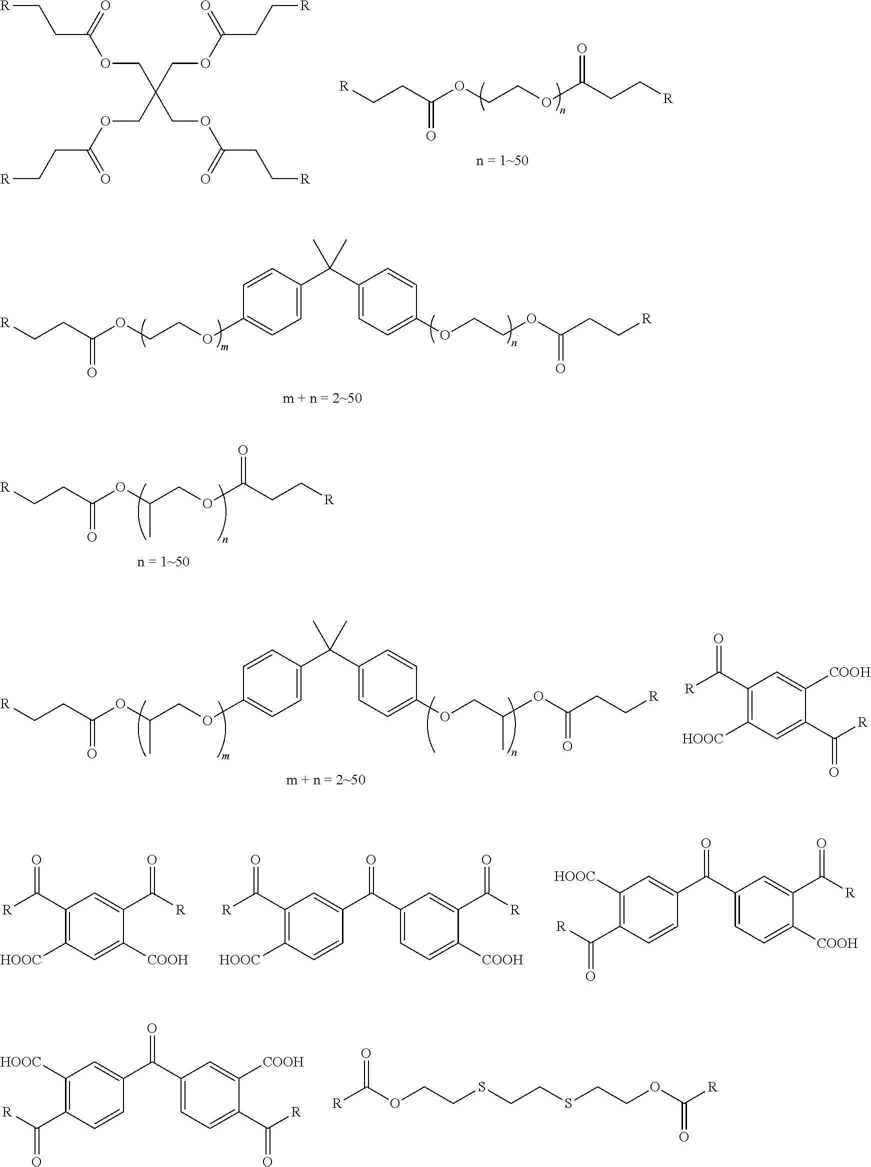

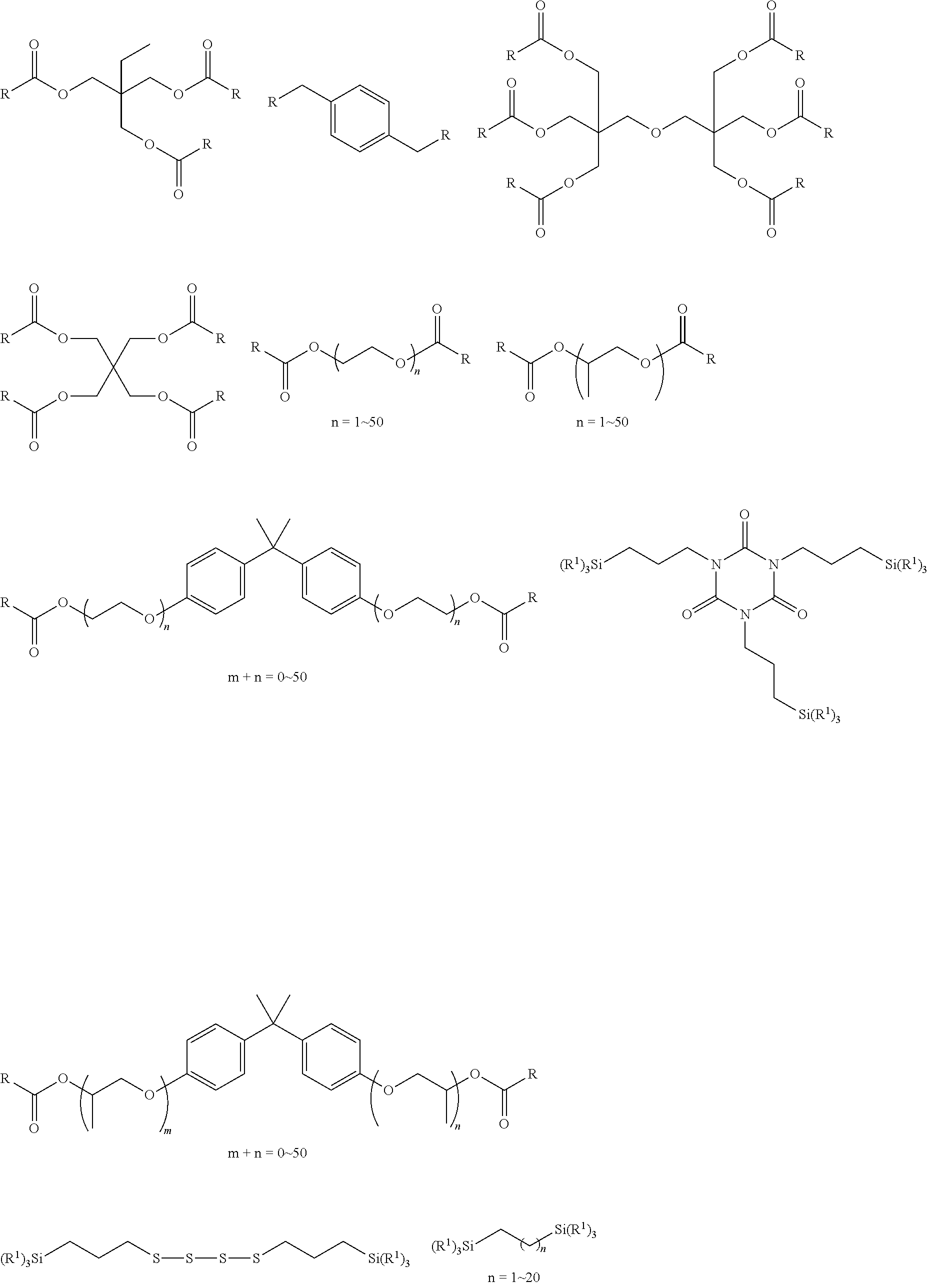

In each of the formulae above, R denotes a partial structure selected from the structures below. When a plurality of Rs and R¹s are present in the molecule, they may be identical to or different from each other, and are preferably identical to each other in terms of synthetic suitability.

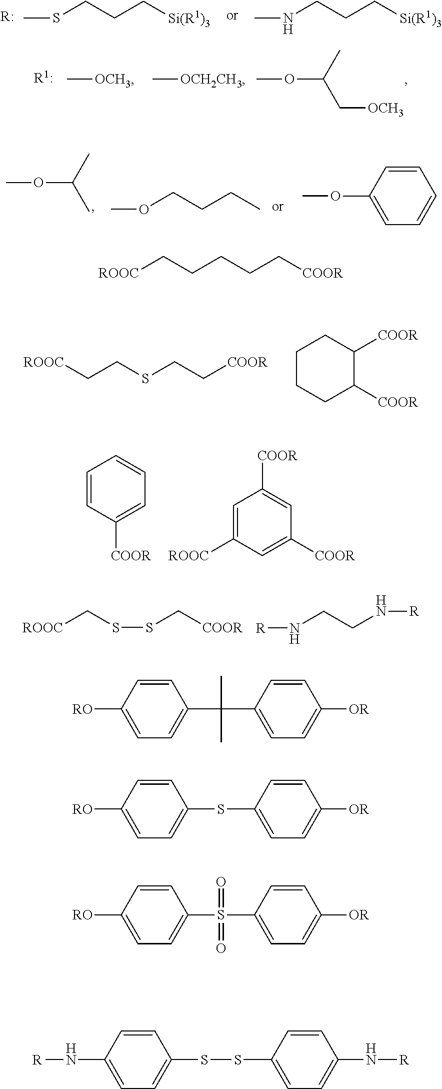

In each of the formulae above, R denotes a partial structure shown below. R¹ is the same as defined above. When a plurality of Rs and R¹s are present in the molecule, they may be identical to or different from each other, and in terms of synthetic suitability are preferably identical to each other.

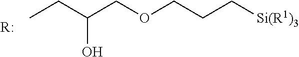

Component D may be obtained by synthesis as appropriate, but use of a commercially available product is preferable in terms of cost. Since Component D corresponds to for example commercially available silane products or silane coupling agents from Shin-Etsu Chemical Co., Ltd., Dow Corning Toray, Momentive Performance Materials Inc., Chisso Corporation, etc., the thermally curable resin composition used in the present invention may employ such a commercially available product by appropriate selection according to the intended application.

As Component D in the present invention, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Among silane compounds as partial (co)hydrolysis-condensation product precursors, from the viewpoint of versatility, cost, and film compatibility, a silane compound having a substituent selected from a methyl group and a phenyl group as a substituent on the silicon is preferable, and specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is preferable to use a dimer (2 moles of silane compound is reacted with 1 mole of water to eliminate 2 moles of alcohol, thus giving a disiloxane unit) to 100-mer of the above-mentioned silane compound, preferably a dimer to 50-mer, and yet more preferably a dimer to 30-mer, and it is also possible to use a partial cohydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

With regard to Component D in the thermally curable resin composition used in the present invention, only one type may be used or two or more types may be used in combination.

The content of Component D contained in the thermally curable layer used in the present invention is preferably in the range of 0.1 to 80 wt % on a solids content basis, more preferably in the range of 1 to 40 wt %, and most preferably in the range of 5 to 30 wt %.

### <(Component E) Photothermal Conversion Agent>

The thermally curable resin composition used in the present invention can preferably further use (Component E) a photothermal conversion agent, in addition to Components A to C. Component E has an absorption wavelength in the range of from 700 nm to 1,300 nm, and it is thought that Component E absorbs laser light in this wavelength range and generates heat to accelerate thermal degradation of the relief-forming layer of the flexographic printing plate of the present invention, thereby enhancing the sensitivity in laser engraving. Component E is preferably used as an infrared absorber in the case of using a laser which emits infrared radiation in the range of from 700 nm to 1,300 nm (a YAG laser, a semiconductor laser, a fiber laser, and a surface emission laser, or the like) as a light source in laser engraving.

As specific compounds of Component E, there are no particular limitations as long as the compound has absorption at a wavelength in the range of from 700 nm to 1,300 nm, but preferred examples include dyes and pigments.

As the dyes, there can be used commercially available products or other known dyes disclosed in, for example, Senryo Binran (Dye Handbook), edited by The Society of Synthetic Organic Chemistry, Japan, published in 1970.

Specific examples thereof include azo dyes, metal complex salt azo dyes, pyrazolone azo dyes, naphthoquinone dyes, anthraquinone dyes, phthalocyanine dyes, carbonium dyes, diimmonium compounds, quinonimine dyes, methine dyes, cyanine dyes, squarylium dyes, pyrylium salts, and metal thiolate complexes, and the like.

Preferable examples of the dyes include cyanine dyes disclosed in JP-A-58-125246, JP-A-59-84356, JP-A-59-202829, JP-A-60-78787 and the like; methine dyes disclosed in JP-A-58-173696, JP-A-58-181690, JP-A-58-194595 and the like; naphthoquinone dyes disclosed in JP-A-58-112793, JP-A-58-224793, JP-A-59-48187, JP-A-59-73996, JP-A-60-52940, JP-A-60-63744 and the like; squarylium dyes disclosed in JP-A-58-112792; and cyanine dyes disclosed in U.K. Patent No. 434,875 and the like.

Furthermore, near infrared ray absorption sensitizers disclosed in U.S. Pat. No. 5,156,938 may also be suitably used, and substituted arylbenzo(thio)pyrylium salts disclosed in U.S. Pat. No. 3,881,924, trimethine thiapyrylium salts disclosed in JP-A-57-142645 (U.S. Pat. No. 4,327,169), pyrylium type compounds disclosed in JP-A-58-181051, JP-A-58-220143, JP-A-59-41363, JP-A-59-84248, JP-A-59-84249, JP-A-59-146063 and JP-A-59-146061, cyanine dyes disclosed in JP-A-59-216146, pentamethine thiopyrylium salts disclosed in U.S. Pat. No. 4,283,475, and pyrylium compounds disclosed in JP-B-5-13514 and JP-B-5-19702 are preferably used. Other preferable examples of the dyes include near infrared ray absorption dyes represented by Formula (I) or (II) described in U.S. Pat. No. 4,756,993.

Also, other preferred examples of Component E used in the present invention include specific indolenine cyanine dyes described in JP-A-2002-278057.

Among these dyes, preferred are a cyanine dye, a squarylium dye, a pyrylium salt, a nickel thiolate complex and an indolenine cyanine dye, more preferred are a cyanine dye and an indolenine cyanine dye.

Specific examples of the cyanine dye which can be suitably used in the present invention include those described in JP-A-2001-133969 (paragraphs [0017] to [0019]), JP-A-2002-40638 (paragraphs [0012] to [0038]), and JP-A-2002-23360 (paragraphs to [0023]).

The dye represented by the following formula (d) or (e) is preferred in view of light-to-heat conversion;

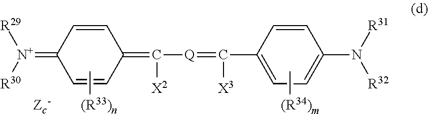

In formula (d), R²⁹ to R³² each independently represents a hydrogen atom, an alkyl group or an aryl group. R³³ and R³⁴ each independently represents an alkyl group, a substituted oxy group or a halogen atom. n and m each independently represents an integer of 0 to 4. The pair of R²⁹ and R³⁰ or the pair of R³¹ and R³² may combine with each other to form a ring. Also, R²⁹ and/or R³⁰ may combine with R³³ to form a ring, or R³¹ and/or R³² may combine with R³⁴ to form a ring. In the case where a plurality of R³³s or R³⁴s are present, R³³s or R³⁴s may combine with each other to form a ring. X² and X³ each independently represents a hydrogen atom, an alkyl group or an aryl group, provided that at least one of X² and X³ represents a hydrogen atom or an alkyl group. Q represents a trimethine group which may have a substituent or a pentamethine group which may have a substituent or may form a ring structure together with a divalent organic group. Zc⁻ represents a counter anion. However, Zc⁻ is not necessary when the coloring matter represented by formula (d) has an anionic substituent in its structure and neutralization of charge is not needed. In view of storage stability of the coating solution for the relief-forming layer, Zc⁻ is preferably a halogen ion, a perchlorate ion, a tetrafluoroborate ion, a hexafluorophosphate ion or a sulfonate ion, particulary preferably a perchlorate ion, a hexafluorophosphate ion or an arylsulfonate ion.

Specific examples of the dye represented by formula (d) which can be suitably used in the present invention include those shown below.

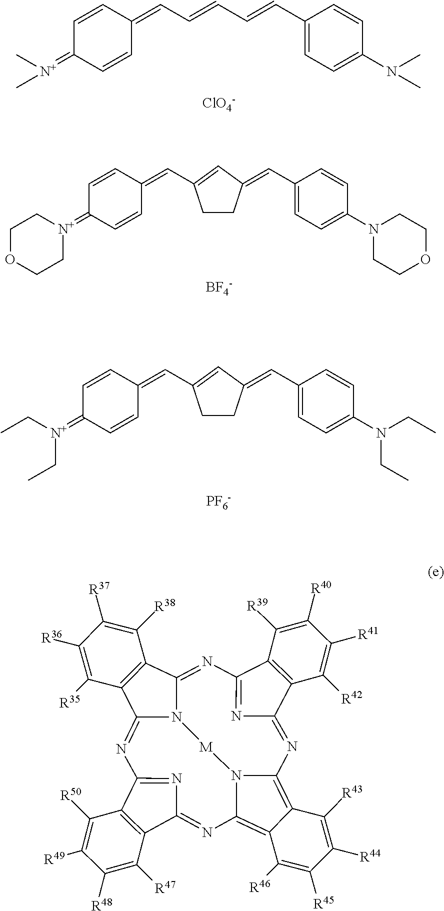

In formula (e), R³⁵ to R⁵⁰ each independently represents a hydrogen atom, a halogen atom, a cyano group, an alkyl group, an aryl group, an alkenyl group, an alkynyl group, a hydroxy group, a carbonyl group, a thio group, a sulfonyl group, a sulfinyl group, an oxy group, an amino group or an onium salt structure. These groups each may have a substituent when a substituent can be introduced thereinto. M represents two hydrogen atoms, a metal atom, a halometal group or an oxymetal group, and examples of the metal atom contained therein include atoms of Groups 1, 2, 13 and 14 of the Periodic Table, transition metals of first, second and third periods, and lanthanoid element. Among these, copper, magnesium, iron, zinc, cobalt, aluminum, titanium and vanadium are preferred.

Specific examples of the dye represented by formula (e) which can be suitably used in the present invention include those shown below.

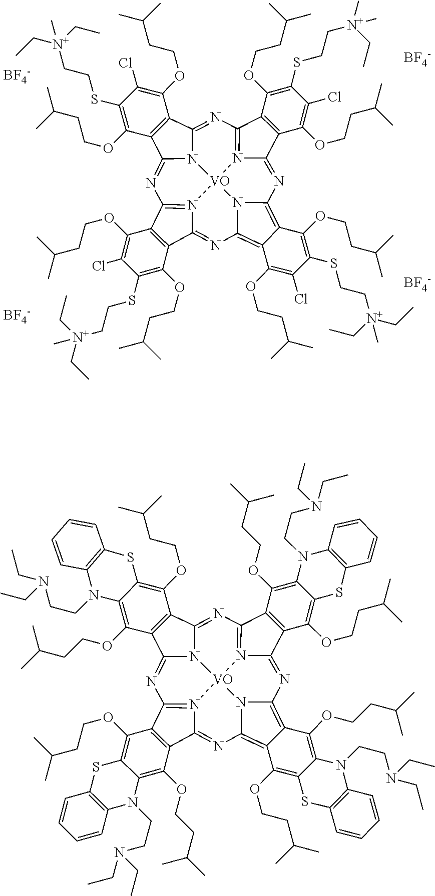

With regard to the pigment used in the present invention, examples of pigments include commercial pigments and pigments described in the Color Index (C.I) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) (CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, inorganic pigments, and carbon black. Among these pigments, carbon black is particularly preferable.

These pigments may be used with or without a surface treatment. The methods of the surface treatment include methods of coating a resin or wax onto the surface, providing attachment of a surfactant, binding a reactive substance (e.g., a silane coupling agent, epoxy compound, polyisocyanate, and the like) to the pigment surface, and the like. The above mentioned surface treatment methods are described in Kinzoku Sekken No Seishitsu To Ohyo (Properties and Applications of Metallic Soaps), published by Saiwai Shobo; Insatsu Inki Gijutsu (Printing Ink Technologies), published by CMC Publishing Co., Ltd. (1984); and Saishin Ganryo Ohyo Gijutsu (Current Pigment Application Technologies), published by CMC Publishing Co., Ltd. (1986).

Furthermore, when the photothermal conversion agent and the binder polymer are used in a combination (condition) such that the thermal degradation temperature of the photothermal conversion agent is equal to or higher than the thermal degradation temperature of the binder polymer, the engraving sensitivity tends to increase, which is preferable.

Specific examples of the photothermal conversion agent used in the present invention include cyanine-based dyes such as heptamethinecyanine dyes; oxonol-based dyes such as pentamethineoxonol dyes; indolium-based dyes, benzindolium-based dyes, benzothiazolium-based dyes, quinolinium-based dyes, and phthalide compounds that have been reacted with color developing agents. Not all the cyanine-based dyes have the light absorption characteristics described above. The light absorption characteristics vary to a very large extent depending on the type of a substituent and the position thereof in the molecule, the number of conjugated bonds, the type of the counterion, the environment in which the dye molecules exist, and the like.

Furthermore, laser dyes, supersaturation absorbing dyes, and near-infrared absorbing dyes that are commonly marketed can also be used. Examples of the laser dyes include “ADS740PP”, “ADS745HT”, “ADS760MP”, “ADS740WS”, “ADS765WS”, “ADS745HO”, “ADS790NH”, and “ADS800NH” (all trade names) manufactured by American Dye Source, Inc. (Canada); and “NK-3555”, “NK-3509”, and “NK-3519” (all trade names) manufactured by Hayashibara Biochemical Laboratories, Inc. Also, examples of the near-infrared absorbing dyes include “ADS775MI”, “ADS775MP”, “ADS775HI”, “ADS775PI”, “ADS775PP”, “ADS780MT”, “ADS780BP”, “ADS793EI”, “ADS798MI”, “ADS798MP”, “ADS800AT”, “ADS805PI”, “ADS805PP”, “ADS805PA”, “ADS805 PF”, “ADS812MI”, “ADS815EI”, “ADS818HI”, “ADS818HT”, “ADS822MT”, “ADS830AT”, “ADS838MT”, “ADS840MT”, “ADS845BI”, “ADS905AM”, “ADS956BI”, “ADS1040T”, “ADS1040P”, “ADS1045P”, “ADS1050P”, “ADS1060A”, “ADS1065A”, “ADS1065P”, “ADS11001”, “ADS1120F”, “ADS1120P”, “ADS780WS”, “ADS785WS”, “ADS790WS”, “ADS805WS”, “ADS820WS”, “ADS830WS”, “ADS850WS”, “ADS780HO”, “ADS810CO”, “ADS820HO”, “ADS821 NH”, “ADS840NH”, “ADS880MC”, “ADS890MC”, and “ADS920MC” (all trade names) manufactured by American Dye Source, Inc. (Canada); “YKR-2200”, “YKR-2081”, “YKR-2900”, “YKR-2100”, and “YKR-3071” (all trade names) manufactured by Yamamoto Chemicals, Inc.; “SDO-1000 B” (trade name) manufactured by Arimoto Chemical Co., Ltd.; and “NK-3508” and “NKX-114” (trade names) manufactured by Hayashibara Biochemical Laboratories, Inc. However, the dyes are not limited only to these.

Furthermore, as the phthalide compounds that have been reacted with color developing agents, those compounds described in Japanese Patent No. 3271226 can be used. Also, phosphoric acid ester metal compounds, for example, complexes of the phosphoric acid esters and copper salts described in JP-A-6-345820 and WO 99/10354 can also be used. Furthermore, fine particles having light absorption characteristics in the near-infrared region and having a volume average particle size of preferably 0.3 μm or less, more preferably 0.1 μm or less, and particularly preferably 0.08 μm or less, can also be used. Examples thereof include metal oxides such as yttrium oxide, tin oxide and/or indium oxide, copper oxide, and iron oxide; and metals such as gold, silver, palladium and platinum. Furthermore, products produced by adding metal ions such as the ions of copper, tin, indium, yttrium, chromium, cobalt, titanium, nickel, vanadium and rare earth elements to particles of glass or the like having a volume average particle size of 5 μm or less, and more preferably 1 μm or less, can be used. Furthermore, metal ions can also be incorporated into microcapsules. In that case, the volume average particle size of the capsule is preferably 10 μm or less, more preferably 5 μm or less, and even more preferably 1 μm or less. Products produced by adsorbing metal ions of copper, tin, indium, yttrium, and rare earth metals to ion exchanger particles can also be used. The ion exchanger particles may be resin particles or inorganic particles. Examples of the inorganic particles include amorphous zirconium phosphate, amorphous zirconium silicate, amorphous zirconium hexametaphosphate, layered zirconium phosphate, network-like zirconium phosphate, zirconium tungstenate, and zeolites. Examples of the resin particles include ion exchange resins and ion exchange celluloses, which are conventionally used.

Most preferred examples of the photothermal conversion agent particularly preferably used in the present invention include carbon black from the viewpoint of stability and efficiency of photothermal conversion. As carbon black, only if there is no such problem as dispersion instability in the composition constituting the relief-forming layer, any of carbon blacks usually used for various applications such as coloring, rubber and dry battery is preferably used, in addition to products falling within standards classified by ASTM.

The carbon black cited here also includes, for example, furnace black, thermal black, channel black, lampblack, acetylene black, etc. Black colorants such as carbon black can be used for the preparation of the thermally curable resin composition as a color chip or a color paste previously dispersed in nitrocellulose or a binder, while using a dispersing agent if necessary for making the dispersion easy. Such chips and pastes can easily be obtained as commercial products.

In the present invention, it is also possible to use carbon blacks having a relatively low specific surface area and relatively low DBP absorption, and microfabricated carbon blacks having a large specific surface area.

Examples of the favorable commercial products of carbon black include Printex U (registered trade mark), Printex A (registered trade mark) and Spezialschwarz 4 (registered trade mark) (all are manufactured by Degussa), SEAST 600 ISAF-LS (manufactured by Tokai Carbon Co., Ltd.), Asahi #70 (N-300) and Asahi #80 (N-220) (manufactured by ASAHI CARBON CO., LTD.), etc.

According to the present invention, a carbon black having an amount of oil absorption of less than 150 ml/100 g is preferable, from the viewpoint of the dispersibility in the thermally curable resin composition.

For the selection of such a carbon black, for example, reference can be made to ‘Carbon Black Binran’ (Carbon Black Handbook) edited by the Carbon Black Association.

When a carbon black having an amount of oil absorption of less than 150 ml/100 g is used, satisfactory dispersibility in the relief-forming layer can be obtained, which is preferable. On the other hand, when a carbon black having an amount of oil absorption of 150 ml/100 g or more is used, the dispersibility in the coating liquid for relief-forming layer tends to deteriorate, and since aggregation of carbon black is likely to occur, the sensitivity becomes non-uniform, which is not preferable. Furthermore, for the purpose of preventing aggregation, it is necessary to intensify the dispersion of carbon black at the time of preparing the coating liquid.

As a method of dispersing Component E, known dispersion techniques that are used in the ink production or toner production can be employed. Examples of dispersion machines include an ultrasonic dispersion machine, a paint shaker, a sand mill, an attritor, a pearl mill, a super mill, a ball mill, an impeller, a disperser, a KD mill, a colloid mill, a dynatron, a three-roll mill, and a pressure kneader. The details are described in Saishin Ganryo Ohyo Gijutsu (Current Pigment Application Technologies), published by CMC Publishing Co., Ltd. (1986).

The content of Component E depends on the size of the molecular extinction coefficient characteristic to the molecule, and is preferably in the range of 0.1 to 15 wt % relative to the total weight of the solids content of the thermally curable layer, more preferably 0.1 to 10 wt %, and particularly preferably 0.1 to 7 wt %.

The volume-average particle size of Component E is preferably in the range of 0.001 to 10 μm, more preferably 0.05 to 10 μm, and particularly preferably 0.1 to 7 μm.

The volume-average particle size of Component E may be measured using a laser-scattering type particle size distribution analyzer.

### <(Component F) Alcohol Exchange Reaction Catalyst>

The thermally curable resin composition used in the present invention can preferably further utilize (Component F) an alcohol exchange reaction catalyst, in addition to Components A to C. In the case of using Component D in the thermally curable resin composition used in the present invention, it is preferable to incorporate (Component F) an alcohol exchange reaction catalyst in order to accelerate the reaction with, for example, the specific binder polymer having a hydroxyl group, which undergoes a crosslinking reaction with the reactive group (hydrolyzable silyl group and/or silanol group) of Component D.

As the alcohol exchange reaction catalyst, any reaction catalyst that is generally used can be applied without limitation.

Hereinafter, an acidic or a basic catalyst, and metal complex catalysts, which are representative alcohol exchange reaction catalysts, will be described in sequence.

### Acidic or Basic Catalyst

As the catalyst, an acidic or a basic catalyst is used as it is or in the form of a solution in which it is dissolved in a solvent such as water or an organic solvent (hereinafter, called an acidic catalyst or a basic catalyst). The concentration when dissolved in a solvent is not particularly limited, and it may be selected appropriately according to the properties of the acidic or basic compound used, desired catalyst content, etc.

The type of the acidic or basic catalyst is not limited, and examples of the acidic catalyst include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, etc, and examples of the basic catalyst include an ammoniacal base such as aqueous ammonia, an amine such as ethyl amine and aniline etc. Among these, from the viewpoint of progressing fastly an alcohol exchange reaction in the layer, methanesulfonic acid, p-toluenesulfonic acid, pyridinium-p-toluene sulfonate, phosphoric acid, phosphonic acid, acetic acid, 1,8-diazabicyclo[5.4.0]undec-7-ene, and hexamethylenetetramine are preferable, and methanesulfonic acid, p-toluenesulfonic acid, phosphoric acid, 1,8-diazabicyclo[5.4.0]undec-7-ene, and hexamethylenetetramineare are particularly preferable.

### Metal Complex Catalyst

The metal complex catalyst that can be used as an alcohol exchange reaction catalyst in the present invention is preferably constituted from a metal element selected from Groups 2, 4, 5, and 13 of the periodic table and an oxo or hydroxy oxygen compound selected from β-diketones (acetylacetone is preferable), ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti is excellent and preferable, and more preferred examples of the metal complex catalyst include ethyl orthotitanate, etc.

These metal complex catalysts are excellent in terms of stability in an aqueous coating solution and an effect in promoting gelling in a sol-gel reaction when thermally drying, and among them, ethyl acetoacetate aluminum diisopropylate, aluminum tris(ethyl acetoacetate), a di(acetylacetonato)titanium complex salt, and zirconium tris(ethyl acetoacetate) are particularly preferable.

The thermally curable resin composition used in the present invention may employ only one type of Component F or two or more types thereof in combination. The content of Component F in the thermally curable resin composition is preferably 0.01 to 20 wt % relative to the content of the non-elastomeric binder having a hydroxy group, and more preferably 0.1 to 10 wt %.

### (Hydrophilic Resin Layer)

According to the present invention, a hydrophilic resin layer is provided on a thermally curable resin composition layer. Hereinafter, the hydrophilic resin layer will be described.

The hydrophilic resin layer refers to a layer containing a hydrophilic resin in an amount of 50 wt % to 100 wt % of the total weight of the resin layer. A hydrophilic resin refers to a resin which dissolves in an amount of 10 g or more in 100 ml of distilled water at 70° C. (also called a water-soluble polymer). Among them, an alkali-soluble resin which is easily dissolvable in an alkaline aqueous solution is preferably used.

Since the hydrophilic resin layer contains a hydrophilic resin which is a water-soluble polymer as a main component, the hydrophilic resin layer is soluble in water, and by further containing an alkali-soluble resin, the hydrophilic resin layer becomes alkali-soluble. Therefore, the hydrophilic resin layer is easily dissolved in water or an aqueous solution containing water as a main component, and can be easily removed by washing in the rinsing step of the platemaking process of a flexographic printing plate.

Furthermore, the hydrophilic resin layer used in the present invention has an oxygen permeability at 25° C. and 1 atmosphere of 30 ml/m²·day·atm or less. When the oxygen permeability is in the range described above, the polymerization reaction of the polymerizable compound in the thermally curable resin layer at the oxygen-shielding layer surface (the surface at which the thermally curable resin layer (relief-forming layer) and the hydrophilic resin layer are in contact) sufficiently proceeds, and the crosslinked relief-forming layer is sufficiently chemically strengthened.

As the hydrophilic resin that can be used in the hydrophilic resin layer, for example, it is preferable to use a water-soluble polymer compound having relatively excellent crystallinity, and specific examples include water-soluble polymers such as polyvinyl alcohol, a vinyl alcohol/vinyl phthalate copolymer, a vinyl acetate/vinyl alcohol/vinyl phthalate copolymer, a vinyl acetate/crotonic acid copolymer, polyvinylpyrrolidone, acidic celluloses, gelatin, gum arabic, polyacrylic acid, and polyacrylamide. These can be used singly or as mixtures of two or more kinds. Among these, it is particularly preferable to use polyvinyl alcohol as a main component, since the most satisfactory results can be obtained in terms of basic characteristics such as oxygen-shieldability and removability by rinsing and washing.

The polyvinyl alcohol used in the hydrophilic resin layer may be partially substituted with ester, ether or acetal as long as it contains unsubstituted vinyl alcohol units for achieving the necessary oxygen-shieldability and water solubility. In the same way, part of the polyvinyl alcohol may have another copolymer component. Specific examples of the polyvinyl alcohol include those having a hydrolysis rate of 71 to 100 mol % and polymerization repeating units of 300 to 2,400. Specific examples thereof include PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613, L-8, and L-9 (manufactured by Kuraray Co., Ltd.).

Furthermore, polyvinyl alcohols of a carboxyl group-modified type, a cationically modified type, an acetoacetyl-modified type, a sulfonic acid-modified type and the like can also be suitably used. Specific examples of these polymers include T-330 H, T-330 ST, T-350, T-230, T-215, K-210, Z-200, Z-200 H, Z-210, Z-100, and F-78 (all manufactured by Nippon Synthetic Chemical Industry Co., Ltd.).

The content of the polyvinyl alcohol in the hydrophilic resin layer is in the range of 0 wt % to 100 wt % relative to the solids content, and is preferably in the range of 50 wt % to 100 wt %, and more preferably in the range of 75 wt % to 100 wt %.

Examples of a resin component other than the polyvinyl alcohol that is contained in the hydrophilic resin layer include water-soluble polymers such as cellulose, polyvinylpyrrolidone, gelatin, polyacrylic acid, polyacrylamide, a vinylpyrrolidone/vinyl acetate copolymer; and non-water-soluble polymer compounds such as polyethylene, polypropylene, polyethylene terephthalate, polystyrene, polycarbonate, nylon, polyamide, and silicone.

Usually, since the hydrophilic resin layer is removed by water at the time of rinsing, the layer itself is preferably water-soluble, and therefore, it is preferable that the hydrophilic resin layer contain a water-soluble polymer as the resin that is used in combination with polyvinyl alcohol. According to a more preferred embodiment, 50% or more of the resin components other than polyvinyl alcohol that are contained in the hydrophilic resin layer includes water-soluble polymers.

Furthermore, as another binder component of the hydrophilic resin layer, a water-soluble polymer containing vinylpyrrolidone as a constituent unit is preferred, and examples thereof include polyvinylpyrrolidone, and a copolymer of vinylpyrrolidone and vinyl acetate.

In the case of using a water-soluble polymer containing polyvinylpyrrolidone as a constituent unit, the proportion of the polymer in the hydrophilic resin layer is not particularly limited, but the proportion is preferably in the range of 5 wt % to 100 wt %, and more preferably in the range of 10 wt % to 50 wt %.

In the hydrophilic resin layer, various organic compounds and inorganic compounds may be added in addition to the polyvinyl alcohol and the other resin components. Also, a surfactant may be added for the purpose of improving coatability for applying the hydrophilic resin layer on the thermally curable resin composition.

The oxygen permeability at 25° C. and 1 atmosphere of the hydrophilic resin layer used in the present invention is 30 ml/m²·day·atm or less, preferably 5 ml/m²·day·atm or less, and more preferably 1 ml/m²·day·atm or less.

The oxygen permeability (ml/m²·day·atm) can be measured according to the gas permeability test methods described in JIS-K7126B and ASTM-D3985, using an OX-TRAN2/21 (registered trademark) manufactured by MOCON, Inc. in an atmospheric environment at 25° C. and 60% RH.

Meanwhile, the control of the oxygen-shielding properties is preferably implemented by using a polyvinyl alcohol (PVA) having high oxygen-shielding properties and a resin having lower oxygen-shielding properties than polyvinyl alcohol in combination, and adjusting the content ratio of the two components, and particularly, it is preferable to use polyvinylpyrrolidone (PVP) or a derivative thereof described above as the resin having lower oxygen-shielding properties. Here, the weight ratio of the contents of PVA/PVP (or a derivative thereof) is preferably 10 or less. Here, in regard to the weight average molecular weight of the (co)polymer such as PVA used herein, a polymer having a weight average molecular weight in the range of 2,000 to 10,000,000 can preferably be used, and more preferably, a polymer having a weight average molecular weight in the range of 10,000 to 1,000,000 is suitable, while a polymer having a weight average molecular weight in the range of 20,000 to 100,000 is yet more preferred.

The weight ratio of the content of PVA to the content of PVP (PVA/PVP) is preferably from 0.5 to 10, and particularly preferably from 4 to 10.

### <Other Components>

In the thermally curable layer and the hydrophilic resin layer used in the present invention, other components that are adequate for the application, production method and the like can be appropriately added. In the following, preferred examples of additives will be described.

### <Polymerization Inhibitor>

In the present invention, in addition to the above-mentioned constitutional components, a small amount of thermal polymerization inhibitor may be added in order to inhibit undesired thermal polymerization of the compound having a polymerizable ethylenically unsaturated bond during the production process or the storage of the composition.

Examples of the suitable thermal polymerization inhibitors include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), and a cerium (I) salt of N-nitrosophenylhydroxylamine.

The addition amount of the thermal polymerization inhibitor is preferably in the range of 0.01 to 10 wt % relative to the total weight of the thermally curable resin composition.

Furthermore in order to avoid polymerization inhibition due to oxygen, a higher fatty acid derivative, for example, behenic acid or behenic amide may be added and allowed to localize on the photosensitive layer surface during the drying step after the coating onto a support, etc., as necessary. The addition amount of the higher fatty acid derivative is preferably in the range of 0.5 to 15 wt % relative to the total weight of the thermally curable resin composition.

### <Filler>

The filler may be an organic compound, an inorganic compound or a mixture thereof. Examples of the organic compound include carbon black, carbon nanotube, fullerene and graphite. Examples of the inorganic compound include silica, alumina, aluminum and calcium carbonate.

### <Plasticizer>

The plasticizer has the function of softening a thermally curable layer and a hydrophilic resin layer used in the present invention and is required to be compatible with a binder polymer. Examples of the plasticizer include diethylene glycol, dioctyl phthalate, didodecyl phthalate, triethylene glycol dicaprate, dimethyl glycol phthalate, tricresyl phosphate, dioctyl adipate, dibutyl cebacate, and triacetylglycerin. The addition amount of the plasticizer is preferably not greater than 60 wt % relative to the total solids content by weight of the resin composition in the resin layer and more preferably not greater than 50 wt %.

### <Colorant>

Furthermore, a colorant such as dye and pigment may be added for the purpose of coloring a thermally curable layer and a hydrophilic resin layer used in the present invention. By this addition, properties such as visibility of the image part or suitability for the image densitometer can be enhanced. As for the colorant, use of a pigment is particularly preferred. Specific examples of the colorant include pigments such as phthalocyanine-based pigment, azo-based pigment, and titanium oxide, and dyes such as Ethyl Violet, Crystal Violet, azo-based dye, anthraquinone-based dye and cyanine-based dye. The amount of the colorant added is preferably in the range of 0.5 to 10 wt % relative to the total weight of the resin composition in the resin layer.

### (Flexographic Printing Plate Precursor for Laser Engraving)

A first embodiment of the flexographic printing plate precursor for laser engraving of the present invention comprises a relief-forming layer (a thermally curable layer) formed from the thermally curable resin composition comprising Component A to Component C, and a hydrophilic resin layer.

A second embodiment of the flexographic printing plate precursor for laser engraving of the present invention comprises a crosslinked relief-forming layer formed by crosslinking a relief-forming layer formed from the thermally curable resin composition comprising Component A to Component C, and a hydrophilic resin layer

In the present invention, the ‘flexographic printing plate precursor for laser engraving’ means both or one of a plate precursor having a crosslinkable relief-forming layer formed from the thermally curable resin composition for laser engraving in a state before being crosslinked and a plate precursor in a state in which it is cured by heat.

In the present invention, the ‘relief-forming layer’ means a thermally curable ayer in a state before being crosslinked by heat, which may be dried as necessary.

In the present invention, the ‘crosslinked relief-forming layer’ means a layer formed by thermally crosslinking the relief-forming layer. Furthermore, the crosslinking is not particularly limited as long as it is a reaction by which the resin composition is cured, example of the crosslinking include one formed by a reaction between Component C and Component D.

The ‘flexographic printing plate’ is prepared by laser engraving a printing plate precursor having a crosslinked relief-forming layer.

Moreover, in the present invention, the ‘relief layer’ means an engraved layer of the flexographic printing plate using a laser, that is, the crosslinked relief-forming layer after laser engraving.

Furthermore, the “(crosslinked) relief-forming layer” as used in the present invention refers to both the relief-forming layer before crosslinking and the relief-forming layer after crosslinking, or either one of them.

The “hydrophilic resin layer” according to the present invention refers to a resin layer that is applied on the relief-forming layer (thermally curable layer), contains a hydrophilic resin as a main component, and is removed at a rinsing step (washing step).

A flexographic printing plate precursor for laser engraving of the present invention comprises a (crosslinked) relief-forming layer formed from the thermally curable resin composition comprising Component A to Component C mentioned above. The (crosslinked) relief-forming layer is preferably provided above a support.

The (crosslinked) flexographic printing plate precursor for laser engraving may further comprise, as necessary, an adhesive layer between the support and the (crosslinked) relief-forming layer and, above the relief-forming layer, a slip coat layer and a protection film.

### <Thermally Curable Layer (Relief-Forming Layer)>

The thermally curable layer used in the present invention is a layer formed from the above-mentioned thermally curable resin composition used in the present invention and is a thermally crosslinkable relief-forming layer.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the thermally curable resin composition that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

### <Hydrophilic Resin Layer>

The flexographic printing plate precursor for laser engraving of the present invention has a hydrophilic resin layer containing a hydrophilic resin as a main component, on the thermally curable layer. When the hydrophilic resin layer containing a hydrophilic resin is laminated on the thermally curable layer, after the thermally curable layer that has been crosslinked by thermal curing (crosslinked relief-forming layer) is laser engraved, the hydrophilic resin layer can be removed by rinsing (washing) with water or a liquid containing water as a main component.

### —Hydrophilic Resin—

The hydrophilic resin that can be incorporated into the hydrophilic resin layer is not particularly limited, but preferred examples include vinyl-based polymers and amide-based polymers. Among these, vinyl-based polymers can be more preferably used.

According to the present invention, a vinyl-based polymer refers to a polymer obtainable from a vinyl compound, and examples include polyvinylpyrrolidone, polyvinyl alcohol, and polyvinyl butyral. Among these, from the viewpoint of having a high degree of hydrophilicity, polyvinyl alcohol is more preferred.

In the case of using, as a hydrophilic resin, a polyvinyl alcohol that is obtained by saponifying polyvinyl acetate, the degree of saponification of the polyvinyl acetate is preferably 50 mol % or higher, more preferably 65 mol % or higher, and particularly preferably 70 mol % or higher. When the degree of saponification is 50 mol % or higher, sufficient hydrophilicity can be imparted to the hydrophilic resin layer.

Furthermore, upon laminating the hydrophilic resin layer on the thermally curable layer, a solvent can be incorporated into the hydrophilic resin composition so as to prepare a coating liquid of the hydrophilic resin composition. As such a solvent, water alone, or a mixed solvent of water and an alcohol-based solvent can be used. Examples of such an alcohol-based solvent include methanol, ethanol, n-propyl alcohol, isopropyl alcohol, glycerin, ethylene glycol, propylene glycol, 1,2-butylene glycol, 1,3-butylene glycol, and 2,3-butylene glycol. These alcohol-based solvents are used by mixing into water in an amount of 50 wt % as the upper limit.

### <Support>

In the present invention, a material having flexibility and excellent dimensional stability is preferably used for the support, and examples thereof include a polyethylene terephthalate film (PET), a polyethylene naphthalate film (PEN), a polybutylene terephthalate film and a polycarbonate film. In view of mechanical properties, shape stability, handleability when making a printing plate and the like of the printing plate precursor, the thickness of the support is preferably 50 to 350 μm, more preferably 100 to 250 m. Also, in order to enhance the adhesion between the support and the relief-forming layer, a known adhesive conventionally used for such a purpose may be provided on the support surface, if desired.

Furthermore, the adhesive property to the relief-forming layer or adhesive layer can be enhanced by applying a physical or chemical treatment to the surface of the support for use in the present invention. Examples of the physical treatment include a sand blast method, a wet blast method of jetting a particle-containing liquid, a corona discharge treatment, a plasma treatment, and an ultraviolet ray or vacuum ultraviolet ray irradiation treatment. Examples of the chemical treatment include a strong acid or strong alkali treatment, an oxidant treatment, and a coupling agent treatment.

### <Adhesive Layer>

When a relief-forming layer is formed on a support, an adhesive layer may be provided between the relief-forming layer and the support for the purpose of strengthening the adhesion between the two layers.

Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in a surface of the printing plate precursor, a protection film may be provided on an outermost surface of the printing plate precursor, as necessary. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

### (Process for Producing Flexographic Printing Plate Precursor for Laser Engraving)

### <Thermally Curable Layer-Forming Step, Hydrophilic Resin Layer-Forming Step>

The process for forming a thermally curable layer and a hydrophilic resin layer of the flexographic printing plate precursor for laser engraving is not particularly limited, but for example, a process of preparing coating liquids of a thermally curable resin composition and a hydrophilic resin composition (both will be collectively referred to as resin compositions for laser engraving), removing the solvent from the coating liquids of these resin compositions for laser engraving as necessary, and then melt extruding the resin compositions on a support, may be used. Alternatively, a method of flow casting the coating liquids of resin compositions for laser engraving on a support, and drying the coated support in an oven to remove the solvent from the resin compositions, may also be used.

Application of the respective layers may be carried out to form one layer each time or plural layers simultaneously, but according to the present invention, it is preferable that the thermally curable layer be applied first, and then the hydrophilic resin layer be applied. The solvent contained in the coating liquids of the resin compositions for laser engraving may be removed after application of each layer, or may be removed together after plural layers are applied.

Among them, the process for producing a flexographic printing plate precursor for laser engraving of the present invention is preferably a production process including, in the following order, a thermally curable layer-forming step of forming a thermally curable layer containing Component A to Component C; a hydrophilic resin layer-forming step of forming a hydrophilic resin layer on the thermally curable layer; and a crosslinking step of crosslinking the thermally curable layer by thermal curing.

In order to shape the flexographic printing plate precursor for laser engraving of the present invention into a sheet form or a cylindrical form, an existing resin-shaping method can be used. Examples thereof include a casting method and a method of extruding the resin from a nozzle or die by using a machine such as pump or extruder and adjusting the thickness with a blade or through calendering by a roller. At this time, the shaping can also be performed under heating within the range of not impairing the performance of the resin. If desired, a rolling treatment, a grinding treatment or the like may also be applied. In many cases, the resin is usually shaped on an underlay called a back film comprising a material such as PET and nickel, but it may be directly shaped on a cylinder of a printing machine. Furthermore, a cylindrical support made of fiber reinforced plastic (FRP), plastic or metal can also be used. A hollow cylindrical support having a constant thickness can be used for reducing the weight. The role of the back film or cylindrical support is to ensure the dimensional stability of the printing plate precursor. Accordingly, a material having high dimensional stability should be selected.

Specific examples of the material include a polyester resin, a polyimide resin, a polyamide resin, polyamideimide resin, a polyetherimide resin, polybismaleimide resin, a polysulfone resin, a polycarbonate resin, a polyphenylene ether resin, a polyphenylene thioether resin, a polyethersulfone resin, a crystalline resin comprising wholly aromatic polyester resin, a wholly aromatic polyamide resin, and an epoxy resin.

These resins may be used in the form of a laminate. For example, a sheet obtained by stacking a polyethylene terephthalate layer having a thickness of 50 μm on both surfaces of a wholly aromatic polyamide film having a thickness of 4.5 μm may also be used. Furthermore, a porous sheet, for example, a cloth formed by knitting fibers, a nonwoven fabric or a film having formed therein fine pores, can be used as the back film. In the case of using a porous sheet as the back film, a high adhesive property for integrating the crosslinked relief-forming layer and the back film can be obtained by impregnating the pores with the relief-forming resin composition and then curing the sheet.

Examples of the fiber forming the cloth or nonwoven fabric include an inorganic fiber such as glass fiber, alumina fiber, carbon fiber, alumina-silica fiber, boron fiber, high silicon fiber, potassium titanate fiber and sapphire fiber; a natural fiber such as cotton and hemp; a semisynthetic fiber such as rayon and acetate; and a synthetic fiber such as nylon, polyester, acryl, vinylon, polyvinyl chloride, polyolefin, polyurethane, polyimide and aramid. In addition, cellulose produced by a bacterium is a high crystalline nanofiber and is a material capable of producing a thin nonwoven fabric having high dimensional stability.

The thickness of the relief-forming layer (the thermally curable layer) in the flexographic printing plate precursor for laser engraving in the present invention can be set freely in accordance with the intended use, and is preferably 0.0005 to 10 mm, more preferably 0.005 to 7 mm.

The thickness of the hydrophilic resin layer of the flexographic printing plate precursor for laser engraving of the present invention is preferably 10 μm to 40 μm, and particularly preferably 20 μm to 40 μm. If the thickness is less than 10 μm or larger than 40 μm, the removal of engraving residue and the dissolution and removal of the hydrophilic resin layer cannot be sufficiently achieved in the rinsing step.

### <Crosslinking Step>

The process for producing a flexographic printing plate precursor for laser engraving of the present invention comprises a crosslinking step in which the flexographic printing plate precursor having a crosslinked relief-forming layer crosslinked by thermally crosslinking the thermally curable layer (the relief-forming layer) used in the present invention.

The thermally curable layer (the relief-forming layer) may be crosslinked by heating the flexographic printing plate precursor for laser engraving (step of crosslinking by heat). As heating means for carrying out crosslinking by heat, there can be cited a method in which a printing plate precursor is heated in a hot air oven or an infrared oven for a predetermined period of time and a method in which it is put into contact with a heated roller for a predetermined period of time.

Due to the thermally curable layer (the relief-forming layer) being thermally crosslinked, firstly, a relief formed after laser engraving becomes sharp and, secondly, tackiness of engraving residue formed when laser engraving is suppressed.

### <Other Layers>

In the present invention, a cushion layer comprising a resin or rubber having cushioning property can be formed between the support and the thermally curable layer or between other layers. In the case of forming a cushion layer between the support and the thermally curable layer, a method of laminating a cushion layer having on one side thereof an adhesive layer while arranging the adhesive layer side toward the support is simple. After laminating the cushion layer, the surface may be shaped through cutting and polishing. In a simpler method, a liquid relief-forming resin composition is coated on the support to a constant thickness and cured to form the cushion layer. For ensuring the cushioning property, the cured product after curing preferably has low hardness. The relief-forming layer having the cushioning property may contain bubbles.

Furthermore, the surface of the cushion layer can be shaped by grinding, polishing and the like, and a cushion layer thus produced is useful as a seamless cushion layer.

### (Flexographic Printing Plate and a Making Process Thereof)

The process for making a flexographic printing plate of the present invention includes, in the following order, an engraving step of laser engraving a flexographic printing plate precursor having a crosslinked relief-forming layer formed by the thermally curable layer-forming step of forming a thermally curable layer, the hydrophilic resin layer-forming step of forming a hydrophilic resin layer, and the crosslinking step of crosslinking the thermally curable layer by thermal curing, which are used in the present invention; and a step of removing the engraving residue generated by engraving and the hydrophilic resin layer using a rinsing liquid.

The flexographic printing plate used in the present invention is a flexographic printing plate having a crosslinked relief-forming layer formed by crosslinking the thermally curable layer by thermal curing, and is preferably a flexographic printing plate made by the process for making a flexographic printing plate of the present invention.

The layer-forming steps and crosslinking step in the process for making a flexographic printing plate of the present invention have the same definitions as the layer-forming steps and crosslinking step in the process for producing a flexographic printing plate precursor for laser engraving described above, and preferred definitions are also the same.

### <Laser Engraving Step>

In the laser engraving step, a relief image is formed on the printing plate precursor by creating digitized data of an image intended to form and operating a laser device by means of a computer.

The laser used in the laser engraving may be any laser as long as the laser has a wavelength which the printing plate precursor can absorb, but in order to perform the engraving at a high speed, a high-power laser is preferred. One preferred example thereof is a laser having an emission wavelength in the infrared or near infrared region, such as carbon dioxide gas laser, YAG laser, semiconductor laser and fiber laser. Also, an ultraviolet laser having an emission wavelength in the ultraviolet region, such as excimer laser, YAG laser wavelength-converted to the third or fourth harmonic and copper vapor laser, can effect the ablation processing of breaking a bond of an organic molecule and is suitable for microfabrication. A laser having an extremely high peak power, such as femtosecond laser, can also be used. The laser irradiation may be either continuous irradiation or pulsed irradiation.

The engraving with a laser is performed under an oxygen-containing gas, generally in the presence of air or in airflow, but may also be performed under a carbon dioxide gas or a nitrogen gas. Washing step (rinsing step) is preferably contained after the completion of engraving. The powdery or liquid engraving residue generated on the flexographic printing plate surface can be removed by an appropriate method, for example, a method of washing it out with a solvent or a surfactant-containing water, a method of spraying an aqueous cleaning agent by means of a high-pressure sprayer, or a method of spraying high-pressure steam.

The resin composition for laser engraving used in the present invention can be applied not only to the relief image for the printing plate but also to various uses such as stamp/seal, design roll for embossing, relief image for patterning an insulator, resistor or electrical conductor paste used for the production of electronic components, relief image for the mold material of ceramic products, relief image for display (e.g., advertising board, sign board), and prototype/matrix of various molded articles.

<Surface Treatment after Laser Engraving>

Furthermore, tackiness on the surface of the printing plate can be reduced and ink wettability of the plate can be improved by forming a modifying layer on the surface of the relief used in the present invention where asperity pattern is formed. Examples of the modifying layer include a coating treated with a compound which reacts with the hydroxy group on the surface, such as silane coupling agent and titanium coupling agent, and a polymer film containing porous inorganic particles. The silane coupling agent widely used is a compound having in its molecule a functional group highly reactive with the hydroxy group on the substrate surface, and examples of the functional group include a trimethoxysilyl group, a triethoxysilyl group, a trichlorosilyl group, a dimethoxysilyl group, a diethoxysilyl group, a dichlorosilyl group, a monomethoxysilyl group, a monoethoxysilyl group and a monochlorosilyl group. At least one of these functional groups is present in the molecule and reacts with the hydroxyl group on the substrate surface, whereby the compound is fixed on the surface. As regards the compound constituting the silane coupling agent, those having in the molecule thereof at least one reactive functional group selected from an acryloyl group, a methacryloyl group, an active hydrogen-containing amino group, an epoxy group, a vinyl group, a perfluoroalkyl group and a mercapto group, or having a long chain alkyl group may be used. Particularly, in the case where the molecule of the coupling agent fixed on the surface has a polymerizable reactive group, crosslinking occurs when the surface after fixing is irradiated with light, heat or electron beam, and a firmer coating can be thereby formed.

The surface treatment liquid is prepared by diluting the coupling agent with a water-alcohol mixed liquid or an aqueous acetic acid solution-alcohol mixed liquid as necessary. The concentration of the coupling agent in the treatment liquid is preferably 0.05 wt % to 10.0 wt %.

The coupling agent treatment method will be explained. The treatment liquid containing a coupling agent is used by applying the treatment liquid on the surface of a printing plate precursor or the surface of a printing plate after laser engraving. The method of applying the coupling agent treatment liquid is not particularly limited, and for example, an immersion method, a spraying method, a roll coating method, or a brush coating method can be applied. Furthermore, the coating treatment temperature and the coating treatment time are also not particularly limited, but the treatment temperature is preferably 5° C. to 60° C., and the treatment time is preferably 0.1 seconds to 60 seconds. Furthermore, it is preferable to perform drying of the treatment liquid layer on the resin layer surface under heating, and the heating temperature is preferably 50° C. to 150° C.

The coupling agent can be immobilized at a high density by generating hydroxyl groups on the printing plate surface, by a method of irradiating the printing plate surface with light in the vacuum ultraviolet region at a wavelength of 200 nm or less using a xenon excimer lamp or the like before treating the printing plate surface with the coupling agent, or by exposing the printing plate surface to a high energy atmosphere such as a plasma.

Furthermore, when a layer containing inorganic porous particles is exposed at the printing plate surface, fine asperity can be formed on the printing plate surface by treating the surface in a high energy atmosphere such as a plasma, and slightly removing the organic substance layer on the surface by etching. Through this treatment, an effect of reducing the tackiness of the printing plate surface, and an effect of enhancing wettability of ink by making the inorganic porous particles exposed to the surface easily absorb ink, can also be expected.

### <Rinsing Step>

The process for making a flexographic printing plate of the present invention preferably includes, after performing the laser engraving step, a rinsing step of washing the engraved surface with water or a liquid containing water as a main component, for the purpose of removing any engraving residue adhering to the engraved surface and for the purpose of dissolving and removing the hydrophilic resin layer.

Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin relief printing plate precursor, and when slime due to engraving residue cannot be eliminated, a rinsing liquid to which a soap or a surfactant is added may be used.

Furthermore, in the present invention a hydrophilic resin layer is preferably formed by an alkali-soluble resin, and the rinsing is more preferably carried out using an alkaline aqueous solution as a rinsing liquid.

As mentioned above, in the present invention the rinsing liquid is preferably alkaline. The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.2, and particularly preferably no greater than 12.5. When in the above-mentioned range, removal of the hydrophilic resin layer by solving is easy and removal of the engraving residue is also easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

Furthermore the rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

### <Drying Step, Post-Crosslinking Step>

The process for making a flexographic printing plate of the present invention may further include a drying step and/or a post-crosslinking step, subsequently to the rinsing step. The drying step is a step of drying the relief layer that has been laser engraved and washed in the rinsing step. The post-crosslinking step is a step of further crosslinking the relief layer by further imparting energy to the relief layer after laser engraving.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

According to the present invention, a flexographic printing plate precursor for laser engraving in which low-rising of the vertices of halftone dots does not easily occur at the time of engraving fine halftone dots of a size of about 10 μm, excellent rinsability is exhibited, and contaminants do not easily adhere, and a flexographic printing plate can be provided.

### EXAMPLES

Hereinafter, the present invention will be described in more detail based on Examples, but the present invention is not construed to be limited to these Examples.

The parts for the addition amount as used in the Examples represents parts by weight, and percentage (%) represents wt %.

The compounds of Component A to Component D used in the Examples and Comparative Examples will be listed below.

A-1: Diethylene glycol dimethacrylate (manufactured by Shin Nakamura Chemical Co., Ltd.)

A-2: Tricyclodecanedimethanol dimethacrylate (DCP) (manufactured by Shin Nakamura Chemical Co., Ltd.)

A-3: Dipentaerythritol hexaacrylate (DPHA) (manufactured by Shin Nakamura Chemical Co., Ltd.)

B-1: t-Butyl peroxybenzoate (PERBUTYL Z; manufactured by NOF CORPORATION)

C-1: DENKA BUTYRAL (product No. #3000-2, Tg: 68° C., manufactured by Denki Kagaku Kogyo K.K.)

C-2: Acrylic resin: cycciohexyl methacrylate/2-hydroxyethyl methacrylate copolymer (mol % ratio, 70/30, Mw=50,000, Tg: 56° C., a synthesis example thereof will be described below)

C-3: Novolac resin A-1077P (Tg: 95° C., manufactured by Sumitomo Bakelite Co., Ltd.)

C-4: Styrene-butadiene copolymer TR2000 (Tg: −80° C., manufactured by JSR Corporation)

D-1: 3-Methacryloxypropyltriethoxysilane (manufactured by Shin-Etsu Chemical Co., Ltd.)

D-2: Bis(triethoxysilylpropyl)tetrasulfide (KBE-846, manufactured by Shin-Etsu Chemical Co., Ltd.)

D-3: Tris(3-trimethoxysilylpropyl) isocyanurate (X-12-965, manufactured by Shin-Etsu Chemical Co., Ltd.)

### (Synthesis Method for C-2)

120 parts by weight of cyclohexyl methacrylate, 56 parts by weight of 2-hydroxyethyl methacrylate and 3 parts by weight of V-601 (dimethyl 2,2′-azobis(2-methylpropionate)) as an initiator were added to 240 parts by weight of methylpropylene glycol, and the mixture was stirred for 4.5 hours at 80° C. in a nitrogen atmosphere. Thus, an acrylic resin (C-2) was synthesized.

The compounds used in the hydrophilic resin layer are listed below.

### <PVA>

PVA105, degree of saponification: 98.5% (manufactured by Kuraray Co., Ltd.)

PVAL-9, degree of saponification: 71% (manufactured by Kuraray Co., Ltd.)<

### PVP>

VPI: LUVITEC VPI55 K18P (manufactured by BASF Corp.)

### Examples 1 to 34 and Comparative Examples 1 to 27

### <Preparation of Coating Liquid for Forming Thermally Curable Layer for Examples 1 to 34>

40 parts by weight of (Component C) the non-elastomeric binder indicated in Table 1 was introduced into a three-necked flask equipped with a stirring spatula and a cooling tube, and 20 parts by weight of diethylene glycol as a plasticizer and 150 parts by weight of tetrahydrofuran as a solvent were introduced therein. The mixture was heated to 70° C. for 120 minutes while being stirred, and thus the binder was dissolved. To this binder dispersion liquid, 0.005 parts by weight of PERBUTYL Z (B-1; t-butyl peroxybenzoate, manufactured by NOF CORPORATION) as (Component B) the thermal polymerization initiator, 3 parts by weight of KBM802 (manufactured by Shin-Etsu Chemical Co., Ltd.) as a chain transfer agent, 5 parts by weight of carbon black as (Component E) the photothermal conversion agent, 0.5 parts by weight of 1,8-diazabicyclo[5.4.0]undec-7-ene (manufactured by Wako Pure Chemical Industries, Ltd.) as (Component F) the alcohol exchange reaction catalyst, 15 parts by weight of (Component A) the polymerizable compound indicated in the following Table 1, and 6 parts by weight of (Component D) the compound having a hydrolyzable silyl group and/or a silanol group were added thereto, and the mixture was stirred. Thus, a coating liquid for forming a thermally curable layer of Example 18 was obtained. Coating liquids for forming a thermally curable layer of Examples 1 to 17 and Examples 19 to 34, respectively containing the components indicated in Table 1 in the respective addition amounts, were obtained in the same manner.

### <Preparation of Coating Liquid for Forming Hydrophilic Resin Layer of Examples 1 to 34>

12 parts by weight in total of polyvinylpyrrolidone (PVP) and polyvinyl alcohol (PVA) at the weight ratio indicated in Table 1, and 1 part by weight of EMALEX 710 (manufactured by Nihon Emulsion Co., Ltd.) were added to 87 parts by weight of pure water in a three-necked flask equipped with a stirring spatula, and the mixture was stirred for 2 hours. Thus, a coating liquid for forming a hydrophilic resin layer of Example 1 having low viscousness was obtained. Coating liquids for forming a hydrophilic resin layer of Examples 2 to 34 were obtained in the same manner, except that the ratio of the addition amounts of PVA/PVP was modified as indicated in Table 1.

### <Production of Flexographic Printing Plate Precursor for Laser, Engraving of Examples 1 to 34>

The coating liquid for forming a thermally curable layer of Example 1 prepared as described above was gently flow cast on a PET substrate to the extent that the coating liquid would not flow out. The coating liquid for forming a hydrophilic resin layer of Example 1 was applied thereon, the coated substrate was heated for 5 hours in an oven at 100° C., and a crosslinked relief-forming layer was formed by thermally crosslinking the layer by removing the solvent and thermal curing. Thus, a flexographic printing plate precursor for laser engraving of Example 1 was produced. The coating liquids for forming a thermally curable layer of Examples 2 to 34 were each applied, and the coating liquids for forming a hydrophilic resin layer were each applied thereon in the same manner, to thereby produce flexographic printing plate precursors for laser engraving of Examples 2 to 34. Hereinafter, the hydrophilic resin layer side of the thermally curable layer will be indicated as a oxygen-shielding layer surface, and the surface on the PET substrate side will be indicated as a PET surface.

### <Production of Flexographic Printing Plate Precursor for Laser Engraving of Comparative Examples 1 to 27>

Preparation of the coating liquids for forming a thermally curable layer and the coating liquids for forming a hydrophilic resin layer was carried out in the same manner as in the Examples described above, using the components and addition amounts indicated in Table 2. A thermally curable layer was provided, a hydrophilic resin layer was applied thereon, and then flexographic printing plate precursors for laser engraving of Comparative Examples 1 to 27 were produced in the same manner as in the Examples.

The following measurements were made using the samples of Examples 1 to 34 and Comparative Examples 1 to 27, and the results are described in Table 1 and Table 2.

### <Measurement of Oxygen Permeability of Hydrophilic Resin Layer>

A prepared coating liquid for forming a hydrophilic resin layer was applied and dried on a polyethylene film having high oxygen permeability (a polyethylene laminate paper produced by dissolving and removing the surface gelatin layer of “EVER-BEAUTY PAPER” manufactured by Fujifilm Corp.), such that the thickness of the hydrophilic resin layer would be the thickness indicated in Table 1, and thus a sample was produced. The oxygen permeability (ml/m²·day·atm) was measured according to the gas permeability test methods described in JIS-K7126B and ASTM-D3985, using an OX-TRAN2/21 (registered trademark) manufactured by MOCON, Inc. in an atmospheric environment at 25° C. and 60% RH.

### <Measurement of Low-Rising of Relief Layer>

A flexographic printing plate precursor was subjected to halftone dot engraving of 20% halftone dots with a width of the vertices of halftone dots of 10 μm, using a carbon dioxide laser engraving machine, and the cross-section of the solid-engraved part was observed with a ultra-deep color 3D profile measuring microscope VK9510 (manufactured by Keyence Corp.) to measure the difference between the height of the vertices of halftone dots and the height of an unengraved area.

As the carbon dioxide laser engraving machine, a “HELIOS 6010” (manufactured by Stork Prints BV) was used. The engraving conditions were set at a laser power output of 500 W, a speed of drum rotation of 800 cm/second, and a relief depth of 0.10 mm, and a solid area which measured 4 cm on each of the four sides was engraved.

While the height of the vertices of halftone dots to be originally reproduced was to be identical with the height of an unengraved area, a phenomenon in which the height of the vertices of halftone dots decreases (low-rising of the vertices of halftone dots) occurs in a fine halftone dot structure due to the melting of the edge areas of the relief. The width of the phenomenon is indicated as the distance of low-rising (μm) in Table 1 and Table 2.

A distance of 30 μm or less is considered as an acceptable level.

### <Measurement of Rinsability>

For the engraving process, the oxygen-shielding layer surface was engraved using a carbon dioxide laser engraving machine “HELIOS 6010” (manufactured by Stork Prints BV). The engraving conditions were set at a laser power output of 500 W, a speed of drum rotation of 800 cm/second, and a relief depth of 0.30 mm, and a solid area which measured 4 cm on each of four sides was engraved.

The sample obtained immediately after laser engraving was not subjected to an operation such as physical rubbing of the engraved surface, but was washed for one minute with tap water at a constant flow rate. The water droplets adhering to the washed surface were wiped away with Kimwipes (registered trademark, manufactured by Nippon Paper Crecia Co., Ltd.), and the engraved surface thus obtained was observed with an SEM (scanning electron microscope; JSM-7401 manufactured by JEOL, Ltd.). Thereby, the presence or absence of engraving residue remaining on the engraved areas was investigated.

Excellent: The engraving residue is in a powder form, and a sharp asperity pattern has been produced.

Fine: The engraving residue is in the form of a highly viscous paste, and a sharp asperity pattern has been produced.

Good: The engraving residue is in the form of a highly viscous paste, and the pattern can be recognized as an asperity pattern.

Poor: The engraving residue is in the form of a less viscous paste, and the pattern can be recognized as an asperity pattern.

Very poor: The engraving residue is in a liquid form, and a sharp asperity pattern is not obtained.

The grades Excellent, Fine, and Good are of an acceptable level.

### <Measurement of Tackiness>

The ease of adherence (tackiness) of contaminants to the relief surface before laser engraving was measured by the method described below, and the results were considered as the results for the measurement of tackiness. The weight of a flexographic printing plate precursor which measured 2 cm on each of the four sides was measured, and then only the oxygen-shielding layer surface side of the flexographic printing plate precursor was firmly pressed on a 100% cellulose paper dust and fine pieces (manufactured by ZELATEX Japan Co., Ltd.) spread in a vat. Paper dust that had not adhered was shaken off, and then the weight of the flexographic printing plate precursor was determined to determine the weight of the adhering paper dust. The weight of the adhering paper dust is indicated in Table 1 and Table 2. A weight of 15 g/m² or less is of an acceptable level.

From the results of Table 1 and Table 2, it was found that the tackiness and rinsability were improved, and rinsability was markedly enhanced. Furthermore, it was found that the low-rising of fine halftone dots was also improved. When the presentation of the density of highlights in an image produced by actually transferring ink onto an object to be printed was examined, it was confirmed that the reproducibility of highlights was satisfactory in the Examples, while the reproducibility of highlights was insufficient in the Comparative Examples.

According to the present invention, a flexographic printing plate precursor for laser engraving and flexographic printing plate in which low-rising of the vertices of halftone dots does not easily occur at the time of engraving fine halftone dots having a size of about 10 μm, rinsability is excellent, and contaminants do not easily adhere can be obtained.

TABLE 1

| | | | | | | Hydrophilic resin layer | | | | Distance | | Amount of |
|---|---|---|---|---|---|---|---|---|---|---|---|---|
| | | Thermally curable layer | | | | (oxygen-shielding layer) | | | | of | | adhering |
| | | Com- | Com- | Com- | Com- | | | Thick- | Oxygen | low-rising | | paper |
| | | ponent | ponent | ponent | ponent | PVA/PVP | PVA | ness | permeability (ml/ | from solid | | dust (g/m²) |
| | No. | A | B | C | D | ratio | (type) | (μM) | m² · day · atm) | area (μm) | Rinsability | (tackiness) |
| Ex- | 1 | A-1 | B-1 | C-1 | None | 1 | PVA105 | 20 | 30 | 30 | Fine | 15 |
| ample | 2 | A-1 | B-1 | C-1 | None | 4 | PVA105 | 20 | 1.2 | 20 | Fine | 6 |
| | 3 | A-1 | B-1 | C-1 | None | 8 | PVA105 | 20 | 0.6 | 18 | Fine | 2 |
| | 4 | A-2 | B-1 | C-1 | None | 1 | PVA105 | 20 | 30 | 27 | Fine | 12 |
| | 5 | A-2 | B-1 | C-1 | None | 4 | PVA105 | 20 | 1.2 | 16 | Fine | 5 |
| | 6 | A-2 | B-1 | C-1 | None | 8 | PVA105 | 20 | 0.6 | 14 | Excellent | 2 |
| | 7 | A-3 | B-1 | C-1 | None | 1 | PVA105 | 20 | 30 | 20 | Fine | 9 |
| | 8 | A-3 | B-1 | C-1 | None | 4 | PVA105 | 20 | 1.2 | 10 | Excellent | 4 |
| | 9 | A-3 | B-1 | C-1 | None | 8 | PVA105 | 20 | 0.6 | 8 | Excellent | 2 |
| | 10 | A-3 | B-1 | C-2 | None | 1 | PVA105 | 20 | 30 | 23 | Fine | 11 |
| | 11 | A-3 | B-1 | C-2 | None | 4 | PVA105 | 20 | 1.2 | 13 | Excellent | 6 |
| | 12 | A-3 | B-1 | C-2 | None | 8 | PVA105 | 20 | 0.6 | 10 | Excellent | 4 |
| | 13 | A-3 | B-1 | C-3 | None | 1 | PVA105 | 20 | 30 | 24 | Fine | 10 |
| | 14 | A-3 | B-1 | C-3 | None | 4 | PVA105 | 20 | 1.2 | 13 | Excellent | 6 |
| | 15 | A-3 | B-1 | C-3 | None | 8 | PVA105 | 20 | 0.6 | 9 | Excellent | 3 |
| | 16 | A-3 | B-1 | C-1 | None | 0 (PVP only) | None | 40 | 30 | 30 | Fine | 15 |
| | 17 | A-3 | B-1 | C-1 | None | — (PVA only) | PVA105 | 20 | 0.1 | 4 | Excellent | 0 |
| | 18 | A-1 | B-1 | C-1 | D-1 | 1 | PVA105 | 20 | 30 | 28 | Fine | 13 |
| | 19 | A-1 | B-1 | C-1 | D-1 | 4 | PVA105 | 20 | 1.2 | 18 | Fine | 5 |
| | 20 | A-1 | B-1 | C-1 | D-1 | 8 | PVA105 | 20 | 0.6 | 16 | Excellent | 2 |
| | 21 | A-1 | B-1 | C-1 | D-2 | 1 | PVA105 | 20 | 30 | 25 | Fine | 10 |
| | 22 | A-1 | B-1 | C-1 | D-2 | 4 | PVA105 | 20 | 1.2 | 16 | Excellent | 4 |
| | 23 | A-1 | B-1 | C-1 | D-2 | 8 | PVA105 | 20 | 0.6 | 14 | Excellent | 1 |
| | 24 | A-1 | B-1 | C-1 | D-3 | 1 | PVA105 | 20 | 30 | 24 | Excellent | 7 |
| | 25 | A-1 | B-1 | C-1 | D-3 | 4 | PVA105 | 20 | 1.2 | 13 | Excellent | 3 |
| | 26 | A-1 | B-1 | C-1 | D-3 | 8 | PVA105 | 20 | 0.6 | 8 | Excellent | 1 |
| | 27 | A-1 | B-1 | C-2 | D-3 | 1 | PVA105 | 20 | 30 | 25 | Excellent | 10 |
| | 28 | A-1 | B-1 | C-2 | D-3 | 4 | PVA105 | 20 | 1.2 | 13 | Excellent | 4 |
| | 29 | A-1 | B-1 | C-2 | D-3 | 8 | PVA105 | 20 | 0.6 | 10 | Excellent | 2 |
| | 30 | A-1 | B-1 | C-3 | D-3 | 1 | PVA105 | 20 | 30 | 23 | Excellent | 9 |
| | 31 | A-1 | B-1 | C-3 | D-3 | 4 | PVA105 | 20 | 1.2 | 13 | Excellent | 3 |
| | 32 | A-1 | B-1 | C-3 | D-3 | 8 | PVA105 | 20 | 0.6 | 9 | Excellent | 1 |
| | 33 | A-3 | B-1 | C-1 | D-1 | 0 (PVP only) | None | 40 | 30 | 30 | Fine | 15 |
| | 34 | A-3 | B-1 | C-1 | D-1 | — (PVA only) | PVA105 | 20 | 0.1 | 13 | Fine | 5 |

TABLE 2

| | | | | | | Hydrophilic resin layer | | | | | | |
|---|---|---|---|---|---|---|---|---|---|---|---|---|
| | | Thermally curable layer | | | | (oxygen-shielding layer) | | | | Distance of | | Amount of |
| | | Com- | Com- | Com- | Com- | PVA/ | | Thick- | Oxygen | low-rising | | adhering paper |
| | | ponent | ponent | ponent | ponent | PVP | PVA | ness | permeability (ml/ | from solid | | dust (g/m²) |
| | No. | A | B | C | D | ratio | (type) | (μM) | m² · day · atm) | area (μm) | Rinsability | (tackiness) |
| Comparative | 1 | A-1 | None | C-1 | None | None | None | None | None | 80 | Very poor | 42 |
| Example | 2 | A-2 | None | C-1 | None | None | None | None | None | 78 | Very poor | 40 |
| | 3 | A-3 | None | C-1 | None | None | None | None | None | 65 | Very poor | 36 |
| | 4 | A-1 | None | C-1 | None | 1 | PVA105 | 20 | 30 | 55 | Very poor | 28 |
| | 5 | A-2 | None | C-1 | None | 4 | PVA105 | 20 | 1.2 | 43 | Very poor | 26 |
| | 6 | A-3 | None | C-1 | None | 8 | PVA105 | 20 | 0.6 | 40 | Very poor | 24 |
| | 7 | A-1 | B-1 | C-1 | None | None | None | None | None | 65 | Very poor | 30 |
| | 8 | A-2 | B-1 | C-1 | None | None | None | None | None | 59 | Very poor | 28 |
| | 9 | A-3 | B-1 | C-1 | None | None | None | None | None | 55 | Very poor | 25 |
| | 10 | A-1 | B-1 | C-4 | None | None | None | None | None | 70 | Very poor | 35 |
| | 11 | A-2 | B-1 | C-4 | None | None | None | None | None | 61 | Very poor | 32 |
| | 12 | A-3 | B-1 | C-4 | None | None | None | None | None | 58 | Very poor | 31 |
| | 13 | A-1 | B-1 | C-4 | None | 1 | PVA105 | 20 | 30 | 45 | Very poor | 25 |
| | 14 | A-2 | B-1 | C-4 | None | 4 | PVA105 | 20 | 1.2 | 40 | Very poor | 23 |
| | 15 | A-3 | B-1 | C-4 | None | 8 | PVA105 | 20 | 0.6 | 38 | Very poor | 21 |
| | 16 | A-1 | B-1 | C-1 | None | 8 | PVA L-9 | 20 | 40 | 45 | Good | 25 |
| | 17 | A-1 | B-1 | C-1 | D-1 | None | None | None | None | 60 | Poor | 27 |
| | 18 | A-1 | B-1 | C-1 | D-2 | None | None | None | None | 56 | Good | 25 |
| | 19 | A-1 | B-1 | C-1 | D-3 | None | None | None | None | 52 | Good | 22 |
| | 20 | A-1 | B-1 | C-4 | D-1 | None | None | None | None | 65 | Very poor | 27 |
| | 21 | A-1 | B-1 | C-4 | D-2 | None | None | None | None | 58 | Poor | 25 |
| | 22 | A-1 | B-1 | C-4 | D-3 | None | None | None | None | 55 | Good | 23 |
| | 23 | A-1 | B-1 | C-4 | D-1 | 1 | PVA105 | 20 | 30 | 42 | Poor | 21 |
| | 24 | A-1 | B-1 | C-4 | D-2 | 4 | PVA105 | 20 | 1.2 | 38 | Poor | 19 |
| | 25 | A-1 | B-1 | C-4 | D-3 | 8 | PVA105 | 20 | 0.6 | 36 | Good | 18 |
| | 26 | A-1 | B-1 | C-1 | D-1 | 8 | PVA L-9 | 20 | 40 | 43 | Good | 20 |
| | 27 | A-1 | B-1 | C-1 | D-1 | 1 | PVA105 | 8 | 70 | 50 | Good | 25 |

What is claimed is:

1. A process for producing a flexographic printing plate precursor for laser engraving, the process comprising, in the following order:
a thermally curable layer-forming step of forming a thermally curable layer comprising (Component A) a polymerizable compound, (Component B) a thermal polymerization initiator, and (Component C) a non-elastomeric binder;
a hydrophilic resin layer-forming step of forming, on the thermally curable layer, a hydrophilic resin layer having a thickness of 10 μm to 40 μm, and an oxygen permeability at 25° C. and 1 atmosphere of 30 ml/m²·day·atm or less; and
a crosslinking step of crosslinking the thermally curable layer by thermal curing.

2. The process for producing a flexographic printing plate precursor for laser engraving according to claim 1, wherein the hydrophilic resin layer comprises an alkali-soluble resin.

3. The process for producing a flexographic printing plate precursor for laser engraving according to claim 1, wherein the hydrophilic resin layer comprises at least one selected from the group consisting of polyvinyl alcohol (PVA), polyvinylpyrrolidone (PVP) and derivatives thereof.

4. The process for producing a flexographic printing plate precursor for laser engraving according to claim 1, wherein the hydrophilic resin layer contains polyvinyl alcohol (PVA) or a derivative thereof, and polyvinylpyrrolidone (PVP) or a derivative thereof.

5. The process for producing a flexographic printing plate precursor for laser engraving according to claim 1, wherein the thermally curable layer further comprises (Component D) a compound having a hydrolyzable silyl group and/or a silanol group.

6. The process for producing a flexographic printing plate precursor for laser engraving according to claim 1, wherein the thickness of the hydrophilic resin layer is 20 μm to 40 μm.

7. The process for producing a flexographic printing plate precursor for laser engraving according to claim 4, wherein the weight ratio of the content of the polyvinyl alcohol (PVA) or a derivative thereof and the content of the polyvinylpyrrolidone (PVP) or a derivative thereof ((content of PVA or a derivative thereof)/(content of PVP or a derivative thereof)) contained in the hydrophilic resin layer is 4 to 10.

8. A process for making a flexographic printing plate, the process comprising, in the following order, the steps of:
engraving a flexographic printing plate precursor for laser engraving produced according to the production process according to claim 1 by laser exposure; and
removing the engraving residue generated by engraving and the hydrophilic resin layer using a rinsing liquid.

9. A flexographic printing plate produced by the process for making a flexographic printing plate according to claim 8.

10. A flexographic printing plate precursor for laser engraving, comprising a relief-forming layer having a crosslinked structure formed by thermally crosslinking a thermally curable layer comprising (Component A) a polymerizable compound, (Component B) a thermal polymerization initiator, and (Component C) a non-elastomeric binder; and a hydrophilic resin layer having a thickness of 10 μm to 40 μm and an oxygen permeability at 25° C. and 1 atmosphere of 30 ml/m²·day·atm or less.

11. The flexographic printing plate precursor for laser engraving according to claim 10, wherein the hydrophilic resin layer is alkali-soluble.

12. The flexographic printing plate precursor for laser engraving according to claim 10, wherein the hydrophilic resin layer comprises an alkali-soluble resin.

13. The flexographic printing plate precursor for laser engraving according to claim 10, wherein the hydrophilic resin layer comprises at least one selected from the group consisting of polyvinyl alcohol (PVA), polyvinylpyrrolidone (PVP) and derivatives thereof.

14. The flexographic printing plate precursor for laser engraving according to claim 10, wherein the hydrophilic resin layer comprises polyvinyl alcohol (PVA) or a derivative thereof, and polyvinylpyrrolidone (PVP) or a derivative thereof.

15. The flexographic printing plate precursor for laser engraving according to claim 10, wherein the thermally curable layer further comprises (Component D) a claim 10, wherein the thermally curable layer further comprises (Component D) a compound having a hydrolyzable silyl group and/or a silanol group.

16. The flexographic printing plate precursor for laser engraving according to claim 10, wherein the thickness of the hydrophilic resin layer is 20 μm to 40 μm.

17. The flexographic printing plate precursor for laser engraving according to claim 14, wherein the weight ratio of the content of the polyvinyl alcohol (PVA) or a derivative thereof and the content of the polyvinylpyrrolidone (PVP) or a derivative thereof ((content of PVA or a derivative thereof)/(content of PVP or a derivative thereof)) contained in the hydrophilic resin layer is 4 to 10.

18. The process for producing a flexographic printing plate precursor for laser engraving according to claim 3, wherein the thermally curable layer further contains (Component D) a compound having a hydrolyzable silyl group and/or a silanol group.

19. The process for producing a flexographic printing plate precursor for laser engraving according to claim 4, wherein the thermally curable layer further contains (Component D) a compound having a hydrolyzable silyl group and/or a silanol group.

20. The process for producing a flexographic printing plate precursor for laser engraving according to claim 19, wherein the weight ratio of the content of the polyvinyl alcohol (PVA) or a derivative thereof and the content of the polyvinylpyrrolidone (PVP) or a derivative thereof ((content of PVA or a derivative thereof)/(content of PUP or a derivative thereof)) contained in the hydrophilic resin layer is 4 to 10.
